(19) United States
(12) Patent Application Publication
(10) Pub. No.: US 2026/0032481 A1
(43) Pub. Date: Jan. 29, 2026

(54) ENHANCEMENTS OF MEASURING AND REPORTING

(71) Applicant: FRAUNHOFER-GESELLSCHAFT ZUR FOERDERUNG DER ANGEWANDTEN FORSCHUNG E.V., Muenchen (DE)

(72) Inventors: Thomas Fehrenbach, Berlin (DE); Baris Goektepe, Berlin (DE); Tatiana Rykova, Berlin (DE); Thomas Wirth, Berlin (DE); Thomas Schierl, Berlin (DE); Cornelius Hellge, Berlin (DE); Thomas Wiegand, Berlin (DE); Alvaro López Raventós, Berlin (DE); Buket Torun, Berlin (DE)

(21) Appl. No.: 19/350,393

(22) Filed: Oct. 6, 2025

Related U.S. Application Data
(63) Continuation of application No. PCT/EP2025/059162, filed on Mar. 4, 2025.

(30) Foreign Application Priority Data
Apr. 4, 2024 (EP) 24168547.8

(51) Int. Cl. H04W 24/08; H04L 41/16

(52) U.S. Cl. CPC H04W 24/08; H04L 41/16

(57) ABSTRACT

A user device, UE, for a wireless communication network, wherein the UE is to perform measurements of one or more performance parameters for at least two beams.

### CROSS-REFERENCE TO RELATED APPLICATIONS

This application is a continuation of copending International Application No. PCT/EP2025/059162, filed Apr. 3, 2025, which is incorporated herein by reference in its entirety, and additionally claims priority from European Application No. 24168547.8, filed Apr. 4, 2024, which is also incorporated herein by reference in its entirety.

### TECHNICAL FIELD

The present invention relates to the field of wireless communication systems or networks, more specifically a concepts for performing measurements and/or determining performance parameters and especially concepts for reporting the measurements. Specific embodiments refer to beam measurement and the corresponding reporting. Some embodiments make use of AI/ML models or support AI and ML concepts.

### BACKGROUND OF THE INVENTION

FIG. 1(A), 1(B) is a schematic representation of an example of a terrestrial wireless network 100 including, as is shown in FIG. 1(A), the core network, CN, 102 and one or more radio access networks RAN₁, RAN₂, . . . RAN_{N}. FIG. 1(B) is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards, e.g., a base station in a 6G network. The BS may also comprise of integrated access and backhaul, IAB, nodes, e.g., an IAB Donor and/or IAB Node, consisting of a central unit, CU, as well as of a distributed unit, DU, and/or containing IAB-MTs including IAB mobile termination, MT. The term base station may refer to an access point, AP, in any of the WiFi standards, e.g., belonging to the IEEE 802.11-familiy. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1(B) shows an exemplary view of five cells, however, the RANₙ may include more or less such cells, and RANₙ may also include only one base station. FIG. 1(B) shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1(B) shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1(B) by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1(B) by the arrows pointing to “gNBs”. A sidelink channel allows direct communication between UEs, also referred to as device-to-device, D2D, communication. The sidelink interface in 3GPP is named PC5. Note, that the term user equipment, UE, or user device may also refer to a station, STA, as used in any of the WiFi standards, e.g., belonging to the IEEE 802.11-familiy.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 5G-Advanced or 6G or 3GPPs NR, New Radio, or within LTE-U, LTE Unlicensed or NR-U, New Radio Unlicensed, which is specified within the LTE and within NR specifications.

The wireless network or communication system depicted in FIG. 1(A), 1(B) may be a heterogeneous network having distinct overlaid networks, e.g., a network of macro cells with each macro cell including a macro base station, like base station gNB₁ to gNB₅, and a network of small cell base stations, not shown in FIG. 1(A), 1(B), like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1(A), 1(B), for example in accordance with the LTE-Advanced Pro or 5G or 5G-Advanced or NR, New Radio, or a possible future 6G radio system.

In mobile communication networks, for example in a network like that described above with reference to FIG. 1(A), 1(B), like an LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1(A), 1(B). This is referred to as an “in-coverage” scenario. Another scenario is referred to as an “out-of-coverage” scenario. It is noted that “out-of-coverage” does not mean that the two UEs are necessarily outside one of the cells depicted in FIG. 1(A), 1(B), rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations or a WiFi AP.

In a wireless network or communication system Artificial Intelligence (AI) and Machine Learning (ML) may be employed for certain tasks. For example, according to 3GPP, AI/ML techniques and data analytics may be incorporated into the 5G system design for supporting certain tasks, e.g., for supporting network automation, data collection for various network functions, network energy savings, load balancing, mobility optimizations, synchronization, modulation and coding scheme (MCS) selection, AI/ML-based services, AI/ML for the new radio (NR) air interface. For example, when considering the NR air interface, AI/ML models may be employed for one or more of the following use cases:
Channel State Information (CSI):
For example, AI/ML may be used for a time-domain prediction of CSI feedback. In another example, AI/ML may be used for compressing CSI feedback.
Beam Management (BM):
For example, AI for beam management in 5G involves the use of AI and ML techniques to improve the efficiency and reliability of a wireless communication using directional beams. Beam management is the process of steering, tracking, and selecting the best beams for each user and link in a 5G network. This is challenging due to factors such as user mobility, a higher number of antennas, and the adoption of higher frequencies, e.g., the adoption of FR2 or FR3. AI and ML may offer valuable solutions to mitigate this complexity and minimize the overhead associated with beam management and selection, while maintaining system performance. For example, AI/ML may be used to interpolate in the spatial domain using measurements from only a few selected beams. This reduces the number of beams that actually have to be transmitted. In another example, AI/ML may also be used to predict the best beams in the temporal domain.
Unlicensed band operation:
For example AI for channel access in unlicensed bands for 5G involves the use of AI and ML techniques to improve the efficiency and reliability of wireless communication using the unlicensed spectrum. The unlicensed spectrum is the part of the radio frequency spectrum that is not allocated to any specific service or operator, and may be used by anyone who follows certain rules and regulations.
The unlicensed spectrum may offer more bandwidth, lower cost, and greater flexibility for 5G applications, especially in scenarios where the licensed spectrum is scarce or expensive. There are some challenges and opportunities of AI for channel access in unlicensed bands for 5G, like:
   Channel access methods: There are different methods for accessing unlicensed channels, such as listen before talk, LBT, gap-based channel access, contention-based random access, etc. Each method has its own advantages and disadvantages in terms of latency, throughput, fairness, and overhead. AI and ML may help to design, optimize, and adapt these methods according to the network conditions and user requirements.
   Spectrum sharing and coexistence: The unlicensed spectrum is shared by multiple users and technologies, such as Wi-Fi, Bluetooth, LTE-U, LAA, MulteFire, CBRS, NR-U, etc. This may cause interference, congestion, and collisions among different transmissions. AI and ML may help to enhance the spectrum sharing and coexistence mechanisms, such as sensing, coordination, scheduling, power control, beamforming, etc., to improve the spectral efficiency and quality of service.
   Private networks and industrial IoT: The unlicensed spectrum may enable the deployment of 5G private networks and industrial IoT applications, such as smart factories, warehouses, mines, etc. These applications have high demands for reliability, security, and low latency. AI and ML may help to customize and optimize the network performance for these applications, such as intelligent load balancing, proactive network slicing, anomaly detection, etc.
Positioning:
For example, a direct AI/ML positioning approach, e.g., fingerprinting, and an AI/ML assisted positioning approach, e.g., the output of the AI/ML model inference is an additional measurement and/or an enhancement of an existing measurement, may be implemented.

The current AI/ML WI considers using AI/ML to predict the DL Tx beam at both UE and NW sides. In case the AI/ML model/functionality runs at the UE-side, the UE determines a beam predicted to be the best in the angular (BM-Case 1) or in the time domain (BM-Case 2). This can be done by predicting the beam IDs or CSI-RS resource indicators (CRIs) or TCI states themselves or by predicting an RSRP value that is associated with that beam. The current reporting framework foresees, see Table 6.3.1.1.2-6 (TS38.212), that the UE reports the CRI and the L1-RSRP of a measured beam. The AI/ML models may be implemented using a model-ID-based Life-Cycle-Management, LCM, or a functionality-based LCM. In the first LCM, AI/ML models may be identified at the network side, and the network may control which AI/ML model is currently used at the UE. The term AI/ML model may further refer not only to a physical model but also to a logical model comprising certain properties. Hence, an AI/ML model may be implemented using different physical AI/ML models. In the functionality-based LCM, the network may have less control over the AI/ML model used at the UE. The actual AI/ML model may be completely transparent to the network, where the network only identifies a functionality that may be enabled by a set of configurations. Nevertheless, a model ID may also be used in a functionality-based LCM.

In case the AI/ML model/functionality runs at the NW-side, the UE performs measurements of the configured reference signals, e.g. SSBs or CSI-RS, and reports L1-RSRPs of the measured beams to the network, where AI/ML prediction of the best transmitted beam takes place.

Starting from the above, there may be a need for improvements or enhancements of measurements, like beam measurements and/or reporting of (beam) measurements.

### SUMMARY

An embodiment may have a user device, UE, for a wireless communication network, wherein the UE is to perform prediction of one or more performance parameters, wherein the UE is to generate a prediction report, like a CSI report, for reporting the predictions, wherein the UE is to operate a plurality of processing cores or processing units (N_CPUs), like CSI processing units, wherein the prediction report is associated with a certain CPU occupation (O_CPU) indicating a number of processing units (N_CPUs) operated simultaneously for generating the prediction report, wherein the UE includes a plurality of processing units, like Artificial Intelligence, AI, cores or Artificial Intelligence/Machine Learning, AI/ML, processing units for running one or more processes, like AI/ML processes for performing one or more tasks on the predictions.

Another embodiment may have a wireless communication network, like a 3rd Generation Partnership Project, 3GPP, system, including one or more inventive user devices, UEs.

According to another embodiment, a method for operating a user device, UE, for a wireless communication network, may have the steps of: performing prediction of one or more performance parameters, generating a prediction report, like a CSI report, for reporting the predictions, operating a plurality of processing cores or processing units (N_CPUs), like CSI processing units, wherein the prediction report is associated with a certain CPU occupation (O_CPU) indicating a number of processing units (N_CPUs) operated simultaneously for generating the prediction report, having access to a plurality of Artificial Intelligence, AI, cores or Artificial Intelligence/Machine Learning, AI/ML, processing units for running one or more AI/ML processes for performing one or more tasks on the predictions.

Another embodiment may have a non-transitory digital storage medium having a computer program stored thereon to perform the inventive method for operating a user device, UE, for a wireless communication network, when said computer program is run by a computer.

### BRIEF DESCRIPTION OF THE DRAWINGS

Embodiments of the present invention are now described in further detail with reference to the accompanying drawings:

FIGS. 1a-1b illustrate a wireless communication network, wherein FIG. 1(A) is a schematic representation of an example of a terrestrial wireless network, and FIG. 1(B) is a schematic representation of an example of a radio access network, RAN;

FIGS. 2a-2b illustrate the mapping of CRI, SSBRI, RSRP as given in the tables in TS 38.212 v17.7.0;

FIG. 3 shows schematic representation of a wireless network communicating to a UE to illustrate the background of embodiments;

FIG. 4 illustrates schematically a UE using a concession configuration for reporting according to an embodiment;

FIGS. 5a-5e show schematic tables illustrating SS-RSRP and CSI-RSRP measurement reports according to embodiments;

FIG. 6 shows a schematic diagram illustrating the occupation dependent on the total number of processing units to illustrate embodiments;

FIGS. 7a and 7b show schematic tables illustrating possible mappings of beams, CPU cores and AI cores according to embodiments;

FIGS. 8a and 8b illustrate schematically possible architectures of processing units including CPU and AI cores according to embodiments;

FIG. 9 shows a schematic diagram illustrating a resulting report size dependent on different reporting modes to illustrate embodiments; and

FIG. 10 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

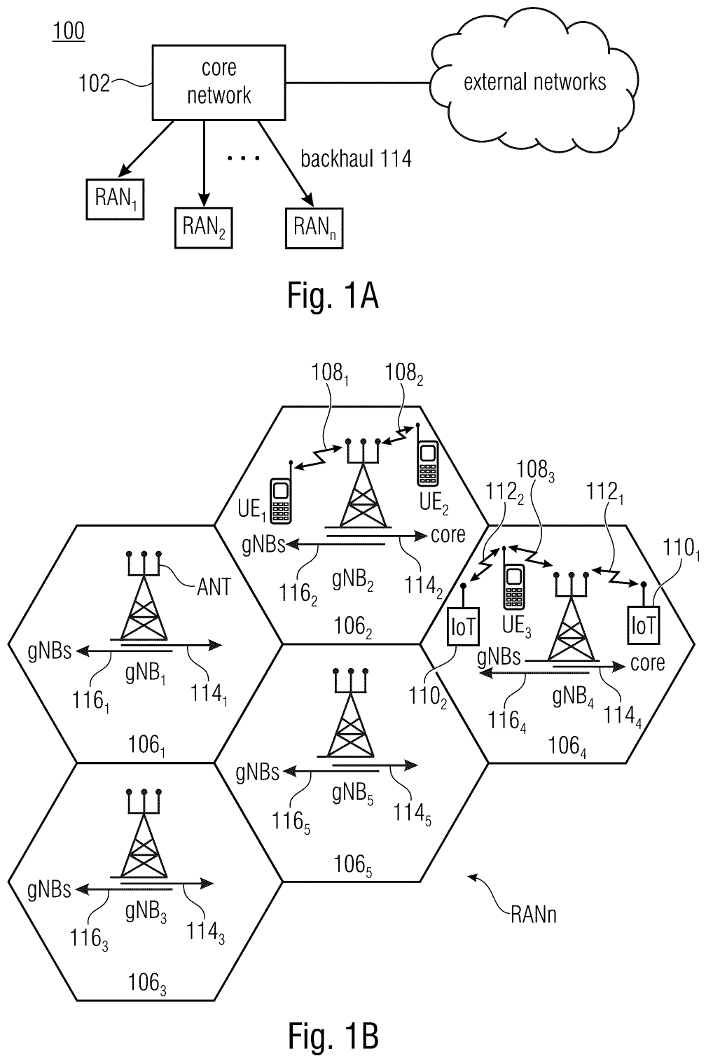

In conventional wireless communication networks or systems, like the one described above with reference to FIG. 1(A), 1(B), which may be a current 5G NR systems, a plurality of measurements, like beam measurements, are used to determine one or more performance parameters. Especially for beam management a plurality of performance parameters are determined which are reported from the one entity, e.g., the UE performing the measurement or determining the performance parameter to another entity, like a gNB or other entities.

### Beam Management

The current CSI reporting framework offers a flexible way for the AI/ML beam report to the NW over Layer 1 (L1). The current CSI-ReportConfig is used to configure the UE with CSI reporting opportunities (e.g. periodic or aperiodic). Such a report is configured using the CSI-ReportConfig information element, which generates a report that includes the CRIs and/or SSBRIs and L1-RSRPs of the up to 4 most powerful beams. However, at the latest 3GPP meeting the companies agreed to extend the number of beam related information in L1 signaling. This might correspond to the reporting of up to 128 beams in one report instance, e.g. for Set A. This direction results in an increased reporting overhead and more measurements at the UE-side, which obviously require more processing power at the UE. Moreover, the given increased signaling might inflate the Uplink Control Channel (UCI) at Layer 1 especially when considering reporting of the measurements for training/re-training purposes. Therefore, the following inventions aim at approaching the above-mentioned problems.

Beam management is a set of techniques to establish and maintain optimal directional links between the base station (gNB) and the user equipment (UE) in 5G networks, especially in the millimeter wave (mmWave) frequency bands. Beam management involves the following procedures:
Beam sweeping: This is the process of covering a spatial area with a set of beams transmitted and received according to pre-specified intervals and directions.
Beam measurement: This is the evaluation of the quality of the received signal at the gNB or at the UE, using metrics such as RSRP, RSRQ, SINR, or SNR.
Beam determination: This is the selection of the suitable beam or beams either at the gNB or at the UE, based on the beam measurements.
Beam reporting: This is the procedure used by the UE to send beam quality and beam decision information to the gNB.

Beam management is performed in both idle mode (when the UE does not have active data transmission) and connected mode (when the UE is exchanging data with the gNB). In idle mode, the UE uses the synchronization signal block (SSB) to perform initial access and cell search. The SSB consists of the primary and secondary synchronization signals (PSS and SSS) and the physical broadcast channel (PBCH), which carry essential information for the UE to synchronize and connect to the gNB. The SSB is transmitted using a fixed beam pattern that covers the entire cell. The UE measures the SSB and reports the best beam index to the gNB. The gNB then uses the reported beam index to steer the beam towards the UE for subsequent transmissions.

In connected mode, the UE and the gNB use different reference signals for beam management. The gNB uses the channel state information reference signal (CSI-RS) to transmit beams for the UE to measure and report. The UE uses the sounding reference signal (SRS) to transmit beams for the gNB to measure and determine. The gNB and the UE also exchange beam failure and recovery information using the radio link control (RLC) and medium access control (MAC) protocols.

In connected mode, the gNB configures the UE with multiple CSI-RS resources, which describe a CSI-RS (reference symbol) in terms of the REs it is transmitted on and its periodicity, its bandwidth, its time offset, etc. One or more CSI-RS resources are bundled in CSI resource sets. One or more CSI resource sets belong to a CSI resource configuration that is usually associated to a CSI report configuration. The CSI-ReportConfig defines how often and when a UE is supposed to report the measurements, e.g. periodically or triggered etc. Then the UE reports per CSI resource set. For beam management purposes, the UE is usually configured to report the L1-RSRP. Then, in a reporting occasion the UE determines up to 4 (depends on configuration) strongest beams and reports their CSI-RS resource indicator (CRI) and the associated L1-RSRP. The CRI is the index of a CSI-RS resource within a CSI resource set by which the beam is uniquely identified. Although the specification does not explicitly talk about beams or beam IDs, in practical deployments each CSI-RS resource is transmitted using a specific refined beam. Hence, the CRI identifies a CSI-RS resource and by that a specific beam. So the terms CRI and beam or beam ID or CSI-RS or CSI-RS resource may be used interchangeably. Furthermore, when the gNB actually transmits data, i.e. PDSCH, to the UE it uses the Transmit Configuration Indicator (TCI) that may be configured or indicated explicitly in the DCI. The TCI state links a data transmission, PDSCH or PUSCH, to up to two reference signals, e.g. a CSI-RS, SSB, SRS etc. Furthermore, it states shared properties of the beams in the form of the quasi-co-location (QCL) parameter. For example, if an SSB and a PDSCH is linked with QCL Type D, it means that they only share Rx properties. In particular, this means that the gNB may use a fine beam for the PDSCH but a coarse beam for the SSB. Both beams although being different share the same direction, hence they are QCLed Type D. In practice, this means that the UE may use the same Rx beam to receive the PDSCH but cannot assume that other parameters are the same. Furthermore, the UE may link a CSI-RS resource to the PDSCH with QCL Type A, which essentially means that the PDSCH and the CSR-RS have been transmitted using the same beam. Hence, the UE can use more reception parameters, such as the Doppler shift, Doppler spread, average delay, delay spread, that it obtained from measuring the said CSI-RS to equalize and decode the PDSCH reception. So, the TCI or TCI state essentially also identifies a certain beam or beam ID and hence, can be used interchangeably. Furthermore, as mentioned previously, SSBs or DMRS or CSI-RS may also be transmitted using a certain beam and the UE may use an SSB ID or SSB index, SSBRI, or DMRS index or CSI-RS resource index, CRI, to identify the certain beam. Hence, the SSB ID, DMRS index and SSB index, SSBRI, and CSI-RS resource index, CRI, may identify a certain beam or beam ID. Beam, Beam index and beam ID may be used interchangeably with the aforementioned terms, such as SSBRI, CRI, DMRS index, etc.

### AI Beam Management

AI for beam management in 5G is a topic that involves the use of artificial intelligence (AI) and machine learning (ML) techniques to improve the efficiency and reliability of wireless communication using directional beams. Beam management is the process of steering, tracking, and selecting the best beams for each user and link in a 5G network. This is challenging due to factors such as user mobility, a higher number of antennas, and the adoption of elevated frequencies. AI and ML can offer valuable solutions to mitigate this complexity and minimize the overhead associated with beam management and selection, while maintaining system performance. Currently, it is discussed in the AI/ML for physical layer study item. The use cases discussed for AI Beam Management focus on:
Spatial-domain Downlink beam prediction for Set A of beams based on measurement results of Set B of beams,
Temporal Downlink beam prediction for Set A of beams based on the historic measurement results of Set B of beams.

### L1-RSRP Reporting (TS38.214 v17.7.0)

For L1-RSRP computation
the UE may be configured with CSI-RS resources, SS/PBCH Block resources or both CSI-RS and SS/PBCH block resources, when resource-wise quasi co-located with ‘type C’ and ‘typeD’ when applicable.
the UE may be configured with CSI-RS resource setting up to 16 CSI-RS resource sets having up to 64 resources within each set. The total number of different CSI-RS resources over all resource sets is no more than 128.

For L1-RSRP reporting, if the higher layer parameter nrofReportedRS in CSI-ReportConfig is configured to be one, the reported L1-RSRP value is defined by a 7-bit value in the range [−140, −44] dBm with 1 dB step size, if the higher layer parameter nrofReportedRS is configured to be larger than one, or if the higher layer parameter groupBasedBeamReporting is configured as ‘enabled’, or if the higher layer parameter groupBasedBeamReporting-r17 is configured, the UE shall use differential L1-RSRP based reporting, where the largest measured value of L1-RSRP is quantized to a 7-bit value in the range [−140, −44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. The mapping between the reported L1-RSRP value and the measured quantity is described in [11, TS 38.133].

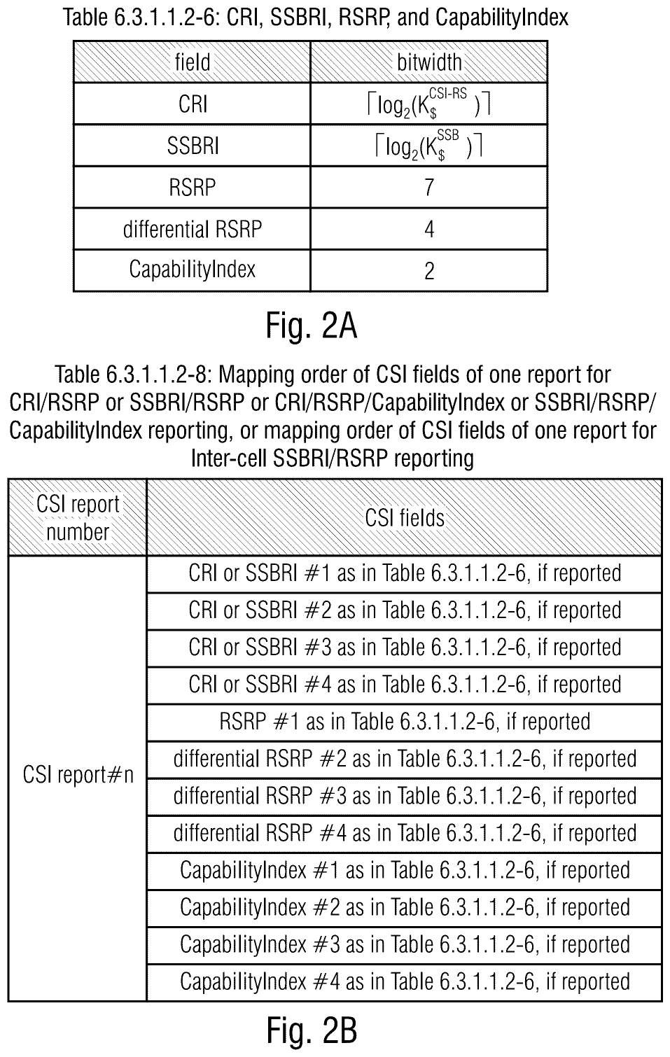

FIGS. 2a and 2b illustrates the mapping of CRI, SSBRI, RSRP as given in the tables in TS38.212 v17.7.0.

### L3-Measurements Reporting

In 5G NR, RSRP measurements may be performed and reported at Layer 1 and Layer 3. For example, UE can provide SS-RSRP measurements at Layer 1 when sending Channel State Information (CSI) and at Layer 3 when sending an RRC: Measurement Report to gNB.

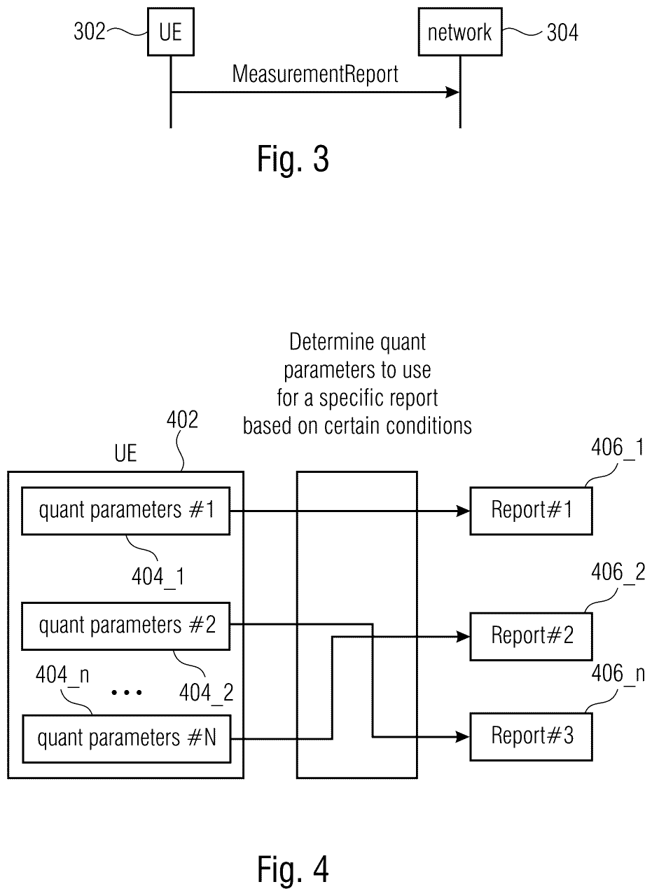

With respect to FIG. 3 a representation of the legacy measurement reporting procedure taken from the 3GPP 38331 (5.5.5) specification is discussed.

FIG. 3 shows a UE 302 reporting on measurements to the network 304, e.g. the base station 304.

Measurements are filtered at Layer 3 to remove the impact of fast fading and to reduce short-term variations in the obtained results. In general, it brings benefits for performing radio resource management decisions, which require a long-term view of channel conditions, e.g. handover procedures.

The general form of the filtering equation for L3 filtering can be represented as (TS 38331 5.5.3.2):

$${F}_{n} = ( 1 - a ) * {F}_{n - 1} + a * {M}_{n}$$

where
Mₙ is the latest received measurement result from the physical layer, e.g. L1-RSRP
Fₙ is the updated filtered measurement result, that is used for evaluation of reporting criteria
Fₙ₋₁ is the old filtered measurement result and
a is the filtering coefficient, often referred to as the filter constant or weighting factor, a=½^{(k/4)}, where k is the filterCoefficient for the corresponding measurement quantity received by the quantityConfig It determines the influence of the current L1 measurement on the filtered result. A smaller value of a results in a smoother but slower response to changes, while a larger value allows the filter to respond more quickly to variations.

In summary, the L3 filtering equation combines historical information with current measurements to produce a smoothed representation of the channel conditions, which is valuable for making radio resource management decisions in 5G NR networks. Adjusting the filtering coefficient allows for a trade-off between responsiveness to changes and stability of the filtered result.

### ASPECT 1

A first aspect/aspect 1 of the present invention concerns a concept of a UE reporting predicted/measured performance values as differential values which are quantized relative to one of the performance values (largest, next largest, etc.,) and being configured with two or more different quantization parameter sets usable for quantizing the differential values.

An embodiment of the present invention provides a user device, UE, for a wireless communication network, wherein the UE is to determine for a performance parameter a plurality of performance values using
a measurement of one or more reference signal resources, and/or
at least one Artificial Intelligence/Machine Learning, AI/ML, model or functionality.

For example, the UE 302 as shown by FIG. 3 may perform the measurement so as to determine a plurality of performance values for a performance parameter. Alternatively to the measurement, AI may be used so as to determine the performance values. According to an embodiment, a combination of performing a measurement and using an AI model may be used as well.

According to embodiments, the UE is to quantize and report at least one of the plurality of performance values as an absolute value and one or some of the plurality of performance values as differential values, wherein a differential value is computed with reference to or relative to one of the plurality of performance values, wherein the UE is configured or preconfigured with two or more different quantization parameter sets, each quantization parameter set including one or more quantization parameters for quantizing the absolute values and/or the differential values, and wherein the UE is to apply at least one of the quantization parameter sets for quantizing the absolute values and/or the differential values.

For example, the quantization parameter set may contain information on both the absolute quant and the differential quant parameters.

Due to the usage of differential values, it is possible to reduce the amount of data for the reporting, so that a plurality of performance values can be reported. The quantization scheme that is used for two or more differential quantization parameters has positive effects on the reporting capabilities.

Specific embodiments are in the field of technical RSRP reporting of CSI-RS with multiple quantization parameters.

According to embodiments, the two or more quantization parameter sets are different in terms of at least one quantization parameter. According to embodiments, the UE is to apply one quantization parameter set for quantizing the absolute values and/or differential values.

According to embodiments, the UE is to apply two or more quantization parameter set for quantizing the absolute values and/or differential values, and wherein the UE uses a first quantization parameter set for a first subset of the absolute values and/or differential values, and a second quantization parameter set for a second subset of the absolute values and/or differential values. For example, a first quantization parameter set, e.g. highly accurate, may be used for the k strongest beams and a second, e.g. less accurate, quantization parameter set for quantizing the remaining beams.

According to embodiments, the “one” performance value may be the largest/smallest value, next larger/smaller value, nth largest/smallest value. Consequently, the one performance parameter may comprise
a largest or smallest performance value, or
a (n+1)^{th} largest or smallest performance value, or
a next larger or smaller performance value relative to the performance value to be reported as differential value.

According to embodiments, the one or more quantization parameters comprise one or more of the following:
one or more quantization intervals, wherein each quantization interval covers a certain range of the performance values and is defined by a lower bound and/or an upper bound, the lower and/or upper bounds associated with respective performance values, e.g., Interval #0: X<−2 dB, Interval #1: −2 dB<=X<0 dB, Interval #2: 0 dB<=X<3 dB, Interval #3: 3 dB<=X<4 dB, . . . , Interval #n: 50 dB<=X
one or more quantization values for each quantization interval, wherein the quantization value may be the arithmetic mean, a geometric mean or any other function which maps the quantization interval to a value between the lower bound and the upper bound of the quantization interval, e.g., arithmetic mean, Interval #5: 4 dB<=X<6 dB is mapped to 5 dB, Interval #6: 6 dB<=X<10 dB is mapped to 8 dB
a start value, e.g., a smallest performance value, e.g. Interval #0: X<−2 dB or e.g. Interval #0: X<=2 dB
an end value, e.g., a largest performance value, e.g. Interval #n: X>50 dB or e.g. Interval #n: X>=50 dB
one or more step sizes for quantizing the performance values, e.g. step size=3 dB, start value=0 dB, end value=9 dB results in the following quantization: Interval #0: X<0 dB, Interval #1:0 dB<=X<3 dB, Interval #2:3 dB<=X<6 dB, Interval #3: 6 dB<=X<9 dB, Interval #4: X>=9 dB
one or more number of steps, e.g., we can also just define start, step-size+number of steps etc.
one or more bit sizes, e.g., a number of bits allocated for absolute or differential performance values, like 4 bits per differential or absolute value. More bits result in a larger number of quantization intervals, i.e. smaller quantization error
one or more reference values to be used as the one performance value, e.g., one or more reference values instead of a largest or smallest performance value, a (n+1) th largest or smallest performance value, or a next larger or smaller performance value,
a quantization strategy, e.g., a configured or pre-configured method used for quantization, e.g. 4 bits per differential or absolute value. More bits result in a larger number of quantization intervals, i.e. smaller quantization error
a requirement on a quantization error, e.g., a relative, absolute or mean squared error (MSE) not to be exceeded, like e.g. choose quantization parameters such that error requirement is not exceed.

According to embodiments, sizes of the respective quantization intervals and/or the one or more step sizes are identical, different or variable.

For example, the quantization strategy may comprise one of the following:
a uniform distribution of the step sizes among all performance values, for example, equally sized quantization intervals
a non-uniform distribution of the step sizes among the performance values, e.g., performance values within a main range of an application are quantized in a finer granular way, e.g., using a first step size, whereas extreme performance values, e.g., performance values above and/or below a configured or preconfigured threshold, are quantized in a coarser way, e.g., using a second step size larger than the first step size,
a configured or preconfigured allocation of step sizes corresponding to a plurality of sets among which the K strongest performance values are distributed in descending order, each set corresponding to the same number of or a varying number of performance values and being associated with a different step size, e.g., a step size increasing from a set including the strongest performance values. For example, in case of same number of performance values Top-3 beams are quantized with step size 1, the next Top-3 beams with step size 2, etc. The given top beams may be selected based on their quality, e.g. RSRP, SINR, SNR. In case of a varying number of performance values, they have to be indicated explicitly. According to another example, uniformly distribute the overall amount of beams to measure among the available number of step sizes, e.g. for 100 beams (max step size is 5): 20 beams are quantized with step size =1, 20 beams with step size 2, 20 beams with step size 3, etc.

According to embodiments, the quantization parameter sets are indicated/configured/preconfigured. For example, the quantization parameter sets may be indicated to the UE by one or more of the following:
a configuration received, e.g., using an RRC message,
a dynamic indication received, e.g., from a gNB via a DCI or a MAC CE message or from another UE via SCI or PC5-RRC or from a WiFi STA or from a 802.11 device,
a preconfiguration, e.g., according to a specification of the wireless communication network.

According to embodiments, the UE is to obtain the configuration including the quantization parameter sets by one or more of the following:
from a broadcast by a cell, e.g., via a MIB and/or a SIB,
during an attach procedure, e.g., when the UE is performing a PRACH,
during a handover or switch from a first cell, e.g., a PCell, to one or more secondary cells, e.g., a SCell,
as part of a handover configuration or a conditional handover, CHO, configuration
responsive to a change in a radio environment within a cell,
responsive to one or more predefined/standardized events, e.g., A1, A2, B1, etc.
responsive to a radio link failure, RLF, on one of the links of the UE, e.g., the UE may be connected to the network or to another UE via multiple links as in dual connectivity and/or carrier aggregation, CA, and/or when using multiple transmit/receive points as in multi-TRP,
responsive to a KPI (in general) or layer-3 KPI, e.g., data throughput drops below a certain threshold, or latency exceeds a certain delay threshold or timeouts or packet error rate, PER, is above a certain threshold, responsive to a change of one or more internal conditions of the UE, e.g., a battery status or memory,
responsive to certain data requirements, e.g., the configuration change may be triggered based on the requirements of the upcoming transmission, such as reliability, latency, priority.

According to embodiments, the UE selects quantization parameter set according to certain criteria: Thus, the UE is to select at least one quantization parameter set to be applied for quantizing the differential values according to one or more criteria. According to embodiments, the one or more criteria comprise one or more of the following:
a dynamic indication, e.g., a DCI or a MAC CE or a SCI, indicating to the UE which quantization parameter set to use (note, the values may also be indicated by another UE, e.g., via SC),
a configuration, e.g., an RRC configuration, configuring the UE to use a certain quantization parameter set,
assistance information from which the UE is able to determine the one quantization parameter set, e.g., when the UE moves from an urban environment to a rural environment. For example, assistance information may indicate that the UE is in an urban area, where more multi-path propagation is expected. This may lead the UE to use quantization parameters that minimize the quantization error, e.g. higher bit size, smaller step size.
a report type requiring a certain quantization parameter set, e.g., whether a report is used for AI/ML or not, or whether a report carries measured and/or predicted values, or whether a report is used for specific LCM purposes such as training
a device type. For example, legacy UEs may only use the state-of-the-art quantization but newer UEs may use the enhanced parameters by default unless indicated otherwise.
an AI/ML model or functionality requiring a certain quantization parameter set. The AI/ML model or functionality may be associated with a certain quantization parameter set. For example, because the AI/ML may be tested with a certain parameter set and only then the corresponding quantization parameters may guarantee an appropriate performance.
one or more internal conditions of the UE, e.g., a battery level, allowing the UE to apply only a certain quantization parameter set,
a frequency band requiring a certain quantization parameter set. Different frequency bands are associated with different propagation characteristics. Hence, the UE may be mandated to use quantization parameters that are matching the requirements of a certain frequency band.
one or more channel conditions. e.g., LOS, NLOS, requiring a certain quantization parameter set. LOS is usually associated with a very strong LOS path and maybe a few strong reflections requiring less accurate quantization. In contrast, NLOS is usually associated with many reflections.
one or more mobility aspects requiring a certain quantization parameter set, e.g., dependent on a speed, an acceleration, a doppler delay profile. The mobility, i.e. speed of UE or speed of surrounding objects (e.g. moving cars on highway), impact the multi-path propagation characteristics of the channel. For example, higher speeds correlate with faster changes of the multi-path components of the channel. This may require less accuracy but more frequent reporting instead.
a resource limitation allowing the UE to apply only a certain quantization parameter set, e.g., a computational complexity, a memory availability, or an energy consumption. For example, the UE may not have sufficient CPU power to compute very accurate quantization but may use less accurate quantization parameters instead. In another example, the size of the report may be limited. Hence, the UE may choose the quantization parameter set based on the report size so that it fits into the resources allocated for the report.
one or more network traffic conditions, e.g., during peak traffic hours larger step sizes may be used to minimize overhead,
one or more properties obtained from the performance parameters e.g. spread of the values, max, min or mean of the values.

According to embodiments, if one or more preconfigured or configured cutoff criteria are fulfilled, the UE does not include a performance value into the report or includes into the report a default value instead of a performance value. According to embodiments, the one or more cutoff criteria comprise one or more of the following:
a performance value or a differential value is below or above a configured or preconfigured threshold,
an error or confidence associated with a performance value or a differential value is below or above a configured or preconfigured threshold,
a difference between sequential performance values or differential values is below or above a configured or preconfigured threshold, e.g. to avoid duplicate values,
a maximum number of performance values to be reported has been reached,
a maximum time threshold between performance values has elapsed; note different subsets of CSI-RS may be configured for measurement for the same Set A of beams in different time intervals. To reduce overhead, such reports may be aggregated if the time between measurements do not exceed a given threshold.

According to embodiments, value exceeding threshold may be signaled directly. According to embodiments, if a performance value exceeds the threshold, the UE is to indicate the performance value using a direct signaling.

According to embodiments, cutoff criteria are applied only in certain situations. According to embodiments, the UE is to apply the one or more cutoff criteria dependent on one or more of the following:
the one or more quantization parameters, e.g., the step size,
a threshold, e.g., a minimum or maximum value, e.g. when differential value is smaller than a threshold =−30 dB meaning quantization is performed on weaker beams we can start applying the cutoff criteria
a purpose of the report, e.g., whether AI/ML is used or not, or for training, or for inference. For example, for training the UE may report all performance values regardless the cutoff criteria but for inference or monitoring some values may be of less importance and hence, the UE may apply the cutoff criteria.
a number of performance values per report. The number of performance values that the UE reports may impact the cutoff criteria. For example, if the UE is configured with a report with a high number of performance values the cutoff criteria may be more relaxed. On the other side, when the number of performance values in a report is small, the cutoff criteria may be more strict so that more performance values are dropped.
a configuration indicating the use of the one or more cutoff criteria, e.g., ‘useCutoff’ is set to ‘True’,
a UE capability, e.g., Some UEs may not be capable of applying all or some or any cutoff criteria.
one or more latency and/or QoS requirements and/or priority, e.g. different QoS, priority and/or latency requirements may be associated with different reporting styles. For example, low latency traffic may require more frequent but potentially less accurate reporting. Instead high priority may indicate that more accurate reporting is required.
a resource limitation, e.g., a computational complexity, a memory availability, or an energy consumption. For example, the UE may not have sufficient CPU power to compute very accurate quantization but may use less accurate quantization parameters instead. In another example, the size of the report may be limited. Hence, the UE may choose the cutoff criteria based on the report size so that it fits into the resources allocated for the report.

According to embodiments, the one or more performance parameters comprise one or more of the following:
one or more beams, which are transmitted by a network entity of the wireless communication system and received at the UE, the performance value indicating a measured or predicted strength of a beam at the UE,
a reference signal received power, RSRP, the performance value indicating the measured or predicted RSRP,
a reference signal received quality, RSRQ, the performance value indicating the measured or predicted RSRQ,
a signal to noise ratio, SNR, the performance value indicating the measured or predicted SNR,
a rank, e.g., rank indicator, RI,
a preferred matrix index, PMI,
a signal to noise and interference ratio, SINR, the performance value indicating the measured or predicted SINR,
a radio signal strength indicator RSSI, the performance value indicating the measured or predicted RSSI,
an interference level, the performance value indicating the measured or predicted interference level,
a doppler parameter, the performance value indicating the measured or predicted doppler parameter,
a delay, the performance value indicating the measured or predicted delay,
a packet loss rate, the performance value indicating the measured or predicted packet loss rate,
an error rate, e.g., a bit error rate, BER, or a packet error rate, PER, indicating the measure or predicted error rates,
one or more parameters reported from higher layers, the performance value indicating the measured or predicted values for the one or more parameters.

According to embodiments, the configuration include an ID of or a reference to the same set or subset of beams and/or an ID of or reference to an AI/ML model or functionality.

According to embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

Note, an embodiment refer to a wireless communication network, like a 3rd Generation Partnership Project, 3GPP, system, comprising a one or more above user devices, UEs.

According to embodiments, the wireless communication network may comprise one or more base stations, BSs, wherein the base station may comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, a satellite payload, e.g., a NTN gNB, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

Embodiments of aspect 1 of the present invention are now described in more detail with reference to the accompanying drawing. It is noted that the subsequently outlined and described aspects or embodiments may be combined such that some or all of the aspects/embodiments are implemented within one embodiment.

According to embodiments the UE 302 of FIG. 3 performs a measurement or in general a determination of performance values to be reported.

To enable support for reporting of more than 4 beams in L1 signaling at least for inference for NW-sided AI/ML model, which enables more efficient and accurate AI/ML model's performance but results in an increased amount of signaling that needs to be reported regularly. As was mentioned previously, the SOTA CSI-RS reporting is organized as follows: in one reporting occasion the UE determines up to 4 strongest beams and reports CRI and the associated L1-RSRP. In order to reduce the overhead, the UE uses the differential L1-RSRP based reporting, where the largest measured value of L1-RSRP is quantized to a 7-bit value in the range [−140, −44] dBm with 1 dB step size (Table 1), and the differential L1-RSRP is quantized to a 4-bit value. The differential L1-RSRP value is computed with 2 dB step size with reference to the largest measured L1-RSRP value which is part of the same L1-RSRP reporting instance (Table 2). The given differential approach might work well with a small number of beams, which might have closely located L1-RSRP values with a small relative to the largest measured value suitable for a quantized 4-bit value.

However, it should be noted that in the framework with much more measured and predicted beams, e.g., 64 or 128 beams, the given state-of-the-art approach might not work, since there might exist very weak beams with a large L1-RSRP difference relative to the largest measured value. In its turn, the network will benefit in receiving the more accurate measurements of the top-K beams that refer to the strongest and most reliable beams detected by the UE. Receiving more accurate values of the top-K beams measurement is crucial for AI/ML model's performance in maintaining a stable and high-quality connection between the UE and the network. Weak beams, on the other hand, are beams that exhibit lower signal strength or quality compared to the top-K beams and may suffer from interference, attenuation, or other impairments. The given beams might not be prioritized for communication, and therefore may be signaled to the network with a larger quantization step resulting in less received accuracy of the measurements. Note that the beams in-between the top-K and weakest beam may be reported with different intermediate values of quantization steps. All in all, the UE might be configured with multiple quantization steps, i.e. step sizes 2, 4, 6, 8, etc. for differential L1-RSRP value, which constitutes the fixed number of bits, e.g. a 4-bit value.

In embodiments of the invention it is proposed to use a new differential L1-RSRP reporting with multiple quantization parameters, which is based on the state-of-the-art approach. In contrast to the SOTA, a quantization scheme that uses two or more different quantization parameters is proposed.

The quantization will be discussed in detail with respect to FIG. 4.

The quantization parameters may comprise one or more of the following:
One or more quantization intervals, e.g. each by a lower and/or upper bound,
Start value, e.g., smallest value,
End value, e.g., largest value,
One or more step sizes,
Quantization value, a quantization interval may be mapped to a single value (designated as quantized value). The quantization value may be the arithmetic mean, geometric mean or any other function which maps a quantization interval to a value between the lower and upper bound of the quantization interval,
Bit size, e.g. the number of bits allocated for absolute or differential RSRPs,
Reference value, e.g., one or more references instead of the largest RSRP,
Quantization strategy, e.g., configured or pre-configured method used for quantization (i.e., uniform, non-uniform quantization),
Requirement on quantization error, e.g., relative, absolute or mean squared error (MSE).

Note, the interval size or step size mentioned above may be equidistant or may also be of a different or variable size, depending on an absolute or relative value wrt., one or more of the measured L1-RSRP value. E.g., in case of a very low L1-RSRP value, values below a minimum threshold, it may be a waste of bits to use a very fine granular quantization, and it may be enough to signal a coarser value. Furthermore, value below a (pre-) configured threshold may not be reported.

In particular, this approach allows to support new quantization parameters, e.g. a larger quantization step, while still supporting old quantization parameters, so that some UEs may support the new parameters but some may not. The proposed quantization scheme may be characterized by the following:

The largest measured/predicted L1-RSRP is quantized as an absolute value to k-bits, e.g. 7 bits (refer to Table 1), whereas all the remaining weaker beams are differential L1-RSRP values, which are computed with a reference to the to the largest/next largest/(n+1)-th largest, where n is an multiple of an integer, measured/predicted/quantized L1-RSRP value and are quantized to m-bits, m<k, e.g. 4 bits.

The number of quantization levels remain the same, but the step sizes of the remaining weaker beams are increased. The allocation of the remaining weaker beams to a certain step size is to be configured. The configuration of the step sizes might correspond to one of the following:
Uniform distribution of step sizes (max value is fixed) among all beams.
Pre-configured/configured allocation of step sizes, corresponding to the fixed number of Top-K beams, i.e. Top-K beams with step size 1, the next Top-K beams with step size 2, etc. Top-K beams may be selected based on their quality, e.g. RSRP, SINR, SNR.
Pre-configured/configured allocation of step sizes, corresponding to the varying number of Top-K beams, i.e. Top-K1 beams with step size 1, Top-K2 beams with step size 2, etc. Top-Kn beams may be selected based on their quality, e.g. RSRP, SINR, SNR,
A non-uniform distribution of step sizes, e.g., the values within the main range of the application are quantized in a finer granular way, whereas the extreme values, e.g., above and/or below a (pre-)configured threshold are quantized in a coarser way, e.g., using a larger step size.

The quantization parameters may be indicated by one or a combination of the following:
Configuration, e.g. using an RRC message (a more static way).
Dynamic indication, e.g. an indication by gNB via DCI, MAC CE message (a more dynamic way).
Pre-configuration, e.g. the specification may pre-configure two or more different quantization parameter sets.

The configuration can also be broadcasted by a cell, e.g., transmitted via MIB and/or SIB, or can be exchanged during the attach procedure, e.g., when a UE is performing a PRACH. Furthermore, the configuration can be exchanged in case a UE is performing a handover or switch from a first cell, e.g., PCell to one or more secondary cells, e.g., SCell. Note, this may involve a fallback procedure, in case the new quantization mechanism is not supported when performing a handover to the new cell. Furthermore, the configuration can be part of a handover configuration or conditional handover, CHO, configuration. In addition, the configuration can be transferred when the radio environment experiences a change within the same cell. Moreover, this configuration adjustment may occur due to changes in the UE internal conditions e.g., battery status or memory. Additionally, modifications to quantization parameters may be needed based on data requirements such as priority, latency etc.

The quantization parameters that are used to generate a report may be chosen by one or a combination of the following:
Dynamic indication, e.g. a DCI or MAC CE may indicate to the UE which parameters to use.
Configuration, e.g. a RRC configuration may configure a UE to use a certain parameter set.
Assistance information, e.g. the UE moves from urban to rural
Report type, e.g. whether report is used for AI/ML or not, whether report carries measured and/or predicted values,
Device type, e.g. AI/ML supporting devices may use new parameters,
AI/ML model or functionality,
The values may also be indicated by another UE, e.g., via SCI,
UE internal conditions e.g., battery level,
Frequency band,
Channel conditions e.g., LOS, NLOS,
Mobility aspects (dependent on speed, acceleration, doppler delay profile),
Resource limitation, e.g., computational complexity, memory availability, or energy consumption.

FIG. 4 shows a UE 402 using a quantization configuration for its reporting. For example, the UE 402 determines the quantization parameters 404_1, 404_2, to 404_n to use for a specific report based on certain conditions. The corresponding reports are highlighted using the reference numerals 406_1 406_2 to 406_n.

Here we provide some example of when a UE may use the above-described procedures to determine which quantization parameters 404_1 to 404_n to use. The dynamic indication may be used to dynamically adapt the quantization parameters, e.g., accuracy in the form of step size. This allows the gNB to adapt the quantization to its current needs. For example, it may be interested in weak beams and hence choose a higher step size sacrificing some accuracy in favor of a larger RSRP range covered by the quantization. In another example, it may choose a smaller step size to increase the accuracy. The configuration may achieve the same results but in a more semi-static and less dynamic manner. The report type may be used to configure the UE with multiple CSI reporting configurations. For example, the gNB may configure the UE with CSI reporting configurations which use the old set of quantization parameters. On top of that it may configure different CSI reporting configuration, e.g. which contain an ExtendedQuant-Information Element (IE), ExtendedReport-IE or an AI-Indicator-IE, which may use the new quantization parameters. This would allow the UE to generate some reports which use the state-of-the-art quantization and some other reports that use the adapted quantization scheme. An exemplary text in the specification may look like the following:

The reporting range of differential SS-RSRP and CSI-RSRP for
L1 reporting and L3 reporting is defined from 0 dBm to −30 dBm
with 2 dB resolution, if extendedReport-r19 is not configured, and
with 4 dB resolution otherwise.

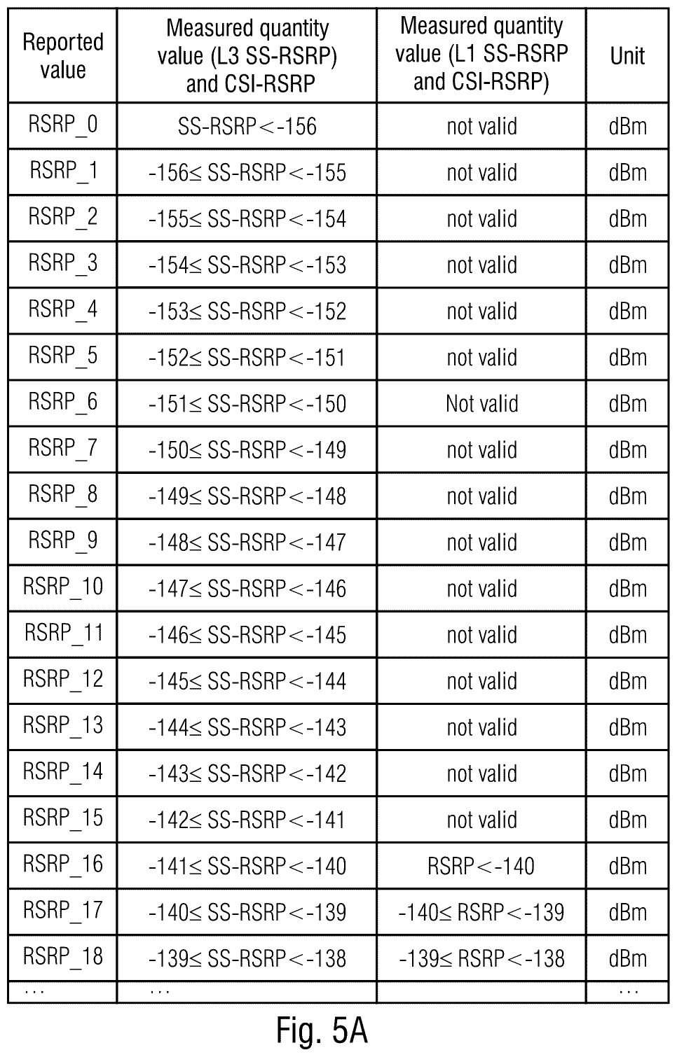

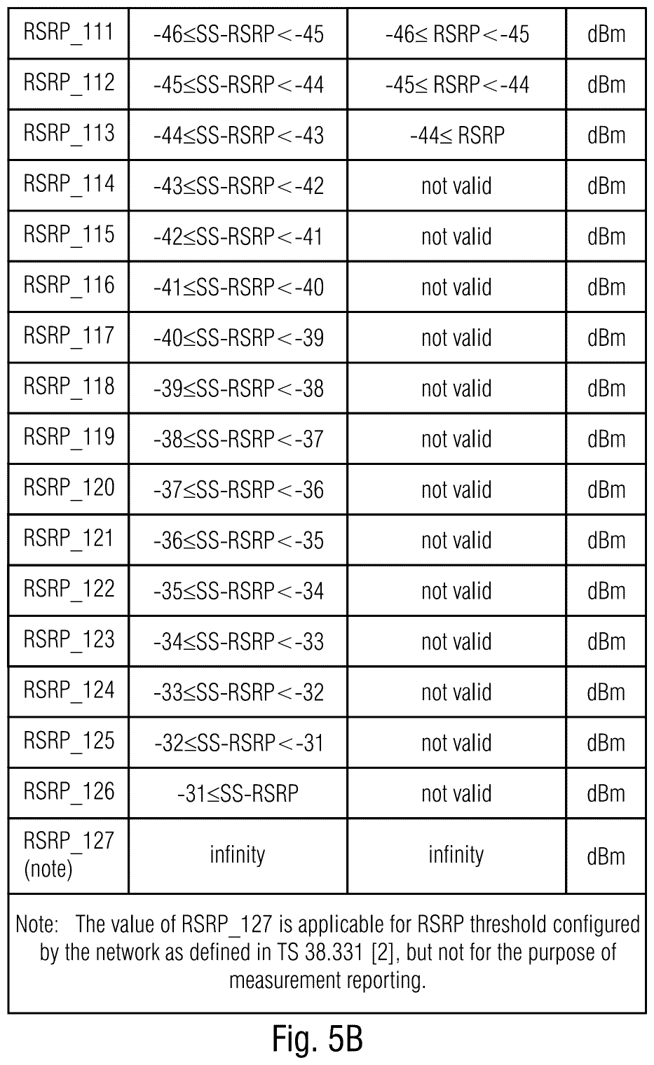

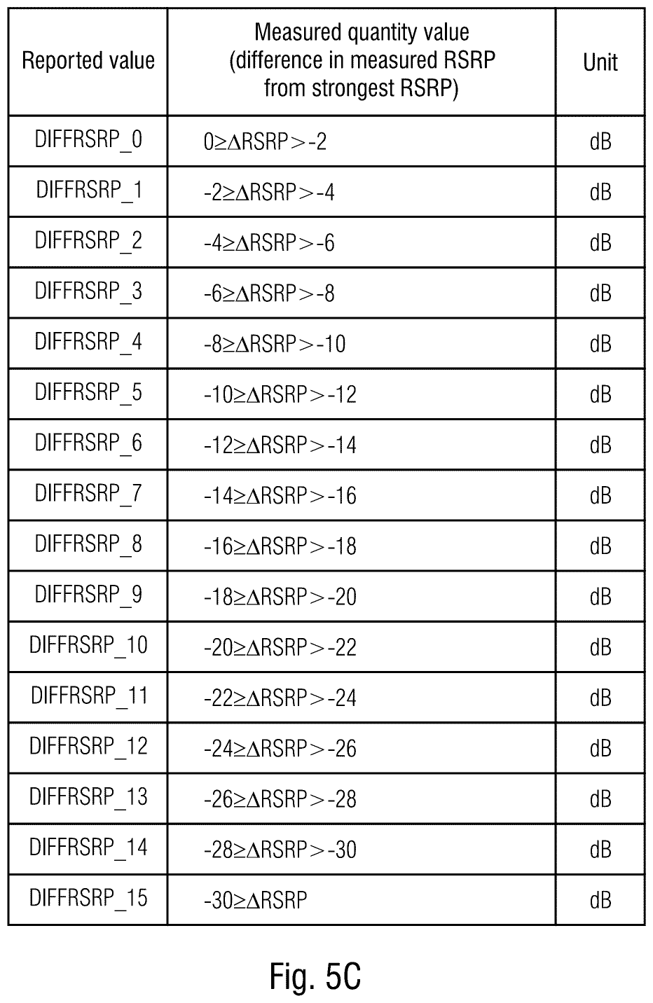

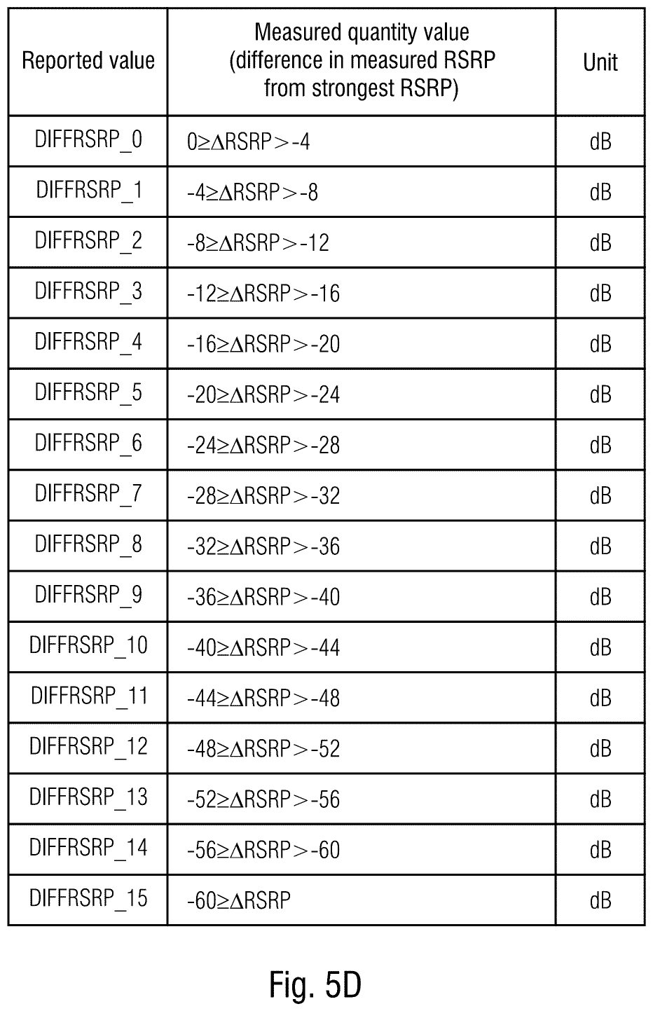

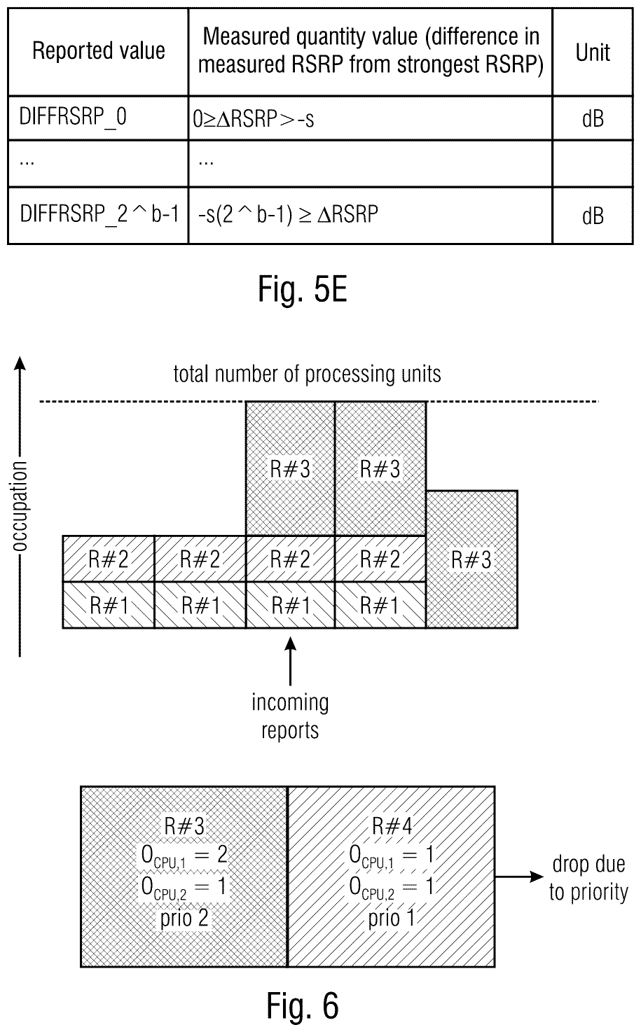

For example, the table illustrated in FIG. 5d provides the differential SS-RSRP and CSI-RSRP measurement (for L1 reporting and L3 reporting) report mapping for RSRP reporting with quantization step size of 4. This would be the case where the second set of quantization parameters is preconfigured. In another example, the table depicted in FIG. 5e in its turn demonstrates the general case report mapping for a quantized b-bit value and s step size. The values of b and s may be up to configuration. For example, the gNB may configure the UE using RRC signaling to indicate which values to use for b and/or s.

The tables illustrated in FIG. 5a and FIG. 5b depict mapping reported values to SS-RSRP and CSI-RSRP measurement reports. As can be seen, the reporting range of SS-RSRP and CSI-RSRP measurement for L3 reporting is defined from −155 dBm to −31 dBm with 1 dB resolution. Depending on the measured quantity value, a reported value, such as RSRP_15, is chosen. In L1 reporting, the reporting range of measurement SS-RSRP and CSI-RSRP is defined from −140 dBm to −44 dBm with a resolution of 1 dB. The RSRP_127 value is an infinite value, i.e., applicable for RSRP thresholds configured by the network as defined in TS38.331, but not for the purpose of measurement reporting.

The table illustrated by FIG. 5c shows a differential SS-RSRP and CSI-RSRP measurement (for L1 reporting and L3 reporting) report mapping for RSRP reporting with quantization step size of 2.

FIG. 5d shows table illustrating differential SS-RSRP and CSI-RSRP measurements (for L1 reporting and L3 reporting) report mapping for extended RSRP reporting.

Table of FIG. 5e illustrates new differential SS-RSRP and CSI-RSRP measurement (for L1 reporting and L3 reporting) report mapping for RSRP reporting of a B-bit value with S step size.

Note that the reporting may further be only for a subset of measurements and is not limited to beams or RSRP values. It can e.g. be used for reporting of SNR, RSRQ, RSSI, SINR, PMI, RI, interference level, doppler, delay or values reported from higher layers.

In another embodiment, the UE may apply a cutoff criterion that is dependent on the quantization parameters. The cutoff criterion may be a threshold on the differential value or the absolute value, after which the UE does not include further beams in the report. For example, when the differential RSRP or absolute RSRP becomes too small or too large, the UE would drop following beams from the report or report default values instead. Furthermore, a value which exceeds a threshold may be indicated using a direct signalling. In this case, the UE would not indicate the KPI, e.g., quantized L1-RSRP value, but would indicate a beam ID, and thus the network would indirectly know, that the signalled beam is above a certain threshold and be a good candidate to assign to the said UE. The cutoff criteria may be fixed by the specification, preconfigured or configured by the network. Furthermore, the cutoff criteria may depend on one or more of the following:
The quantization parameters, e.g. the step size,
A threshold, e.g., a minimum or maximum value,
The purpose of the report, e.g. whether AI/ML is used or not, or for training, or for inference,
The number of beams per report,
A configuration, e.g., ‘useCutoff’ is set to ‘True’,
A UE capability,
Latency and QoS requirements,
Resource limitation, e.g., computational complexity, memory availability, or energy consumption.

For example, if the quantization step is 2 dB the UE may not apply the cutoff criteria and report the configured number of beams. But if the quantization step is 4 dB, the cutoff criteria may be applied. This ensures that UEs that use the state-of-the-art RSRP reporting do not need to change their behavior but when the newly introduced report is used, the UE may apply the cutoff criteria.

### ASPECT 2

A second aspect 2 of the present invention concerns a UE performing measurements of performance parameters and reporting the measurements using first and second layers, e.g., L1 or L2.

An embodiment provides a user device, UE, for a wireless communication network, wherein the UE is to perform measurements of one or more performance parameters. The UE is to report the measurements using a signaling according to
a first layer of a wireless communication network protocol stack, or
a second layer of the wireless communication network protocol stack, the second layer, e.g. Layer 3, L3, being higher than the first layer, e.g., Layer 1, L1,
   wherein the UE is to select the signaling dependent on one or more criteria.

Just exemplarily, the reference to FIG. 3 is given, where the UE 302 performs the measurement, but as discussed above by reporting the measurement using signaling according to first layer or a second layer.

Specifically, embodiments of these aspects refer to the L3 reporting of L1-measurements.

According to embodiments, a clarification for further distinguishing from the known technology, namely that measurements are nor processed, like filtered in L3, can be made. Thus, according to embodiments, the UE is to include the measurements into one or more second layer signaling messages according to the first layer without any further processing of the measurements, e.g., such as filtering or averaging.

According to embodiments, the clarification the L1/L2 messages serve as container for measurements. Thus, according to embodiments, the UE is to use a first layer message as a container for the measurements, and/or a second layer message, like an RRC message at Layer 3, as a container for the measurements.

According to embodiments, the usage of the first and second layer has the advantage that it is insured that reliable and consistent data are provided to the network side (especially when using L2 reporting or L3 reporting), while the signal overhead is reduced (especially when using L1).

According to embodiments, layer selected dependent on number of measurements to be reported. Thus, according to embodiments, the one or more criteria comprise a number of measurements to be reported, wherein the UE is to use a first layer signaling for a report if the number of measurements to be reported is below a configured or preconfigured threshold, and wherein the UE is to use a second layer signaling for the report if the number of measurements to be reported is at or above the configured or preconfigured threshold.

According to embodiments, layer selected dependent on latency associated with the measurements are to be reported. Consequently, according to embodiments, the one or more criteria comprise a latency requirement associated with the measurements to be reported, wherein the UE is to use a first layer signaling for a report if a required latency associated with the measurements to be reported is below a configured or preconfigured threshold, and wherein the UE is to use a second layer signaling for the report if the required latency associated with the measurements to be reported is at or above the configured or preconfigured threshold.

According to embodiments, layer selected dependent on use case associated with measurements are to be reported. This means according to embodiments, that the one or more criteria comprise a use case associated with the measurements to be reported, wherein the UE is to use a first layer signaling for a report if the measurements to be reported are associated with one or more first use cases, and wherein the UE is to use a second layer signaling for the report if the measurements to be reported are associated with one or more second use cases.

According to embodiments, the one or more criteria comprise one or more of:
a number of measurements to be reported.
a total size of the report,
a latency requirement,
a type of measurement,
a use case or purpose of a report,
an indication or configuration from the network,
an availability of resources or scheduling,
a performance degradation, e.g., less resources assigned to a said UE,
a Quality of Service (QOS) requirement, e.g., for error correction, like error correction mechanisms may be applied at the second layer signaling
a resource utilization requirement, e.g., for resource aggregation (e.g. smaller data packets aggregated into larger ones at second layer signaling for the report can reduce overhead and improve overall network efficiency).

According to embodiments (first use case), the one or more first use cases comprise one or more of the following:
reporting the measurements for inference of at least one Artificial Intelligence/Machine Learning, AI/ML, model or functionality (e.g. used for AI/ML beam management),
reporting the measurements for monitoring or managing at least one Artificial Intelligence/Machine Learning, AI/ML, model or functionality (e.g., used for AI/ML beam management if the measurements indicate that a certain action, like an AI/ML model switching or fallback to a legacy non-AI/ML beam management, is to be performed during a time period not exceeding a configured or preconfigured threshold or in case no action is required, e.g. when UE sends regular monitoring reports of a subset of beams to the NW.).

According to embodiments (second use case), the one or more second use cases comprise one or more of the following:
reporting the measurements for training at least one Artificial Intelligence/Machine Learning, AI/ML, model or functionality (e.g., used for AI/ML beam management),
reporting the measurements for monitoring or managing at least one Artificial Intelligence/Machine Learning, AI/ML, model or functionality (e.g., used for AI/ML beam management if the measurements indicate that a certain action, like an AI/ML model training or retraining, is to be performed during a time period exceeding the configured or preconfigured threshold).

According to embodiments, a layer may be selected dependent on configuration. Thus, according to embodiments, the one or more criteria comprise a measurement configuration with which the UE is selectively configured, wherein the UE is to use a first layer signaling for a report if the measurement configuration indicates that a certain action, like a performance monitoring of an AI/ML model, is to be performed during a time period not exceeding a configured or preconfigured threshold, and wherein the UE is to use a second layer signaling for the report if the measurement configuration indicates that a certain action, like inference or training or re-training of an AI/ML model, is to be performed during a time period exceeding the configured or preconfigured threshold.

According to embodiments, L1 and filtered L3 reporting is used. Filtering the raw L1-RSRP measurements allows for the removal of outliers and noise fluctuations result in more accurate, reliable and consistent data. This legacy data (or part of it) can be sent together with layer 1 measurements, e.g. L1-RSRP, on a higher layer as a combined/mixed report for performance monitoring purposes and/or to optimize AI/ML model/functionality operation. According to embodiments, the UE is to use a second layer signaling for reporting the measurements and a second layer signaling for reporting filtered measurements or values to be used for normalizing feedback data as a combined report and help to decide on one or more of:
quantization steps and/or step size,
quantization algorithm to use,
frequency of sending feedback data.

According to embodiments, filtered L1 and filtered/unfiltered L3 reporting is used. The filtered/averaged L1-RSRP measurements may be signaled over layer 1 to reduce the effects of delays and additional protocol processing, which in its turn will allow faster action at the NW-side to ensure a stable AI/ML model's operation over time. According to embodiments, the UE is to use a first layer signaling for reporting filtered measurements and a second layer signaling for reporting unfiltered or filtered measurements.

Another embodiment refers to neighboring cell measurement. According to embodiments, the second layer is used if criterion for use case “performing measurement for a neighboring cell” or “network triggered handover (e.g. considering the AI/ML)” is fulfilled.

According to embodiments, neighboring cell measurements may include optional filtering. Here, the measurements comprise a first layer measurements of one or more neighboring cells, e.g. RSRP measurements; and/or wherein the measurements are filtered at second layer, e.g. to reduce noise fluctuations and/or to remove outliers.

According to embodiments, neighboring cell prediction excluding filtering may be used. According to embodiments, the UE is to predict predicted first layer values by AI/ML model applying; and/or wherein predicted first layer values (e.g. L1-RSRP values) for the one or more neighboring cells are directly reported using the second layer or reported without applying the filter function if AI/ML model is applied (for prediction).

According to embodiments, the one or more performance parameters comprise one or more of the following:
one or more beams, which are transmitted by a network entity of the wireless communication system and received at the UE, the performance value indicating a measured or predicted strength of a beam at the UE,
a reference signal received power, RSRP, the performance value indicating the measured or predicted RSRP,
a reference signal received quality, RSRQ, the performance value indicating the measured or predicted RSRQ,
a signal to noise ratio, SNR, the performance value indicating the measured or predicted SNR,
a rank,
a PMI,
a signal to noise and interference ratio, SINR, the performance value indicating the measured or predicted SINR,
a radio signal strength indicator RSSI, the performance value indicating the measured or predicted RSSI,
an interference level, the performance value indicating the measured or predicted interference level,
a doppler parameter, the performance value indicating the measured or predicted doppler parameter,
a delay, the performance value indicating the measured or predicted delay,
a packet loss rate, the performance value indicating the measured or predicted packet loss rate,
one or more parameters reported from higher layers, the performance value indicating the measured or predicted values for the one or more parameters.

According to embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

An embodiment provides a wireless communication network, like a 3rd Generation Partnership Project, 3GPP, system, comprising one or more user devices, UEs.

According to embodiments, the wireless communication network comprises one or more base stations, BSs, wherein the base station may comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, a satellite payload, e.g., a NTN gNB, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

Embodiments of aspect 2 of the present invention are now described in more detail with reference to the accompanying drawing. It is noted that the subsequently outlined and described aspects or embodiments may be combined such that some or all of the aspects/embodiments are implemented within one embodiment.

For example, the UE 302 of FIG. 3 may perform the measurement and the reporting.

The beam report for AI/ML beam management use case can provide the following functionalities for the NW-sided model:
Reporting for model training
Reporting for model inference
Reporting for model monitoring
Reporting for AI/ML model/functionality management
   and for UE-sided model:
Reporting based on the results of model inference
Reporting for model monitoring
Reporting for model inference
Reporting for AI/ML model/functionality management

The current CSI reporting framework offers a flexible way for the AI/ML beam report to the NW over Layer 1 (L1). The current CSI-ReportConfig is used to configure the UE with CSI reporting opportunities (e.g. periodic or aperiodic). In each CSI report the UE might report the CSI-RS resource indicator (CRI) or SS/PBCH Block Resource indicator (SSBRI), and the L1-RSRP or SINR for the beams.

As agreed at the previous 3GPP meeting, a beam report sent from the UE to the network will be signaled in Layer 1 at least for inference of beam management use case for NW-sided models. The decision to send e.g. L1-RSRP measurements over Layer 1 is primarily driven by efficiency and timeliness. Layer 1 provides direct access to the raw received signal power without any processing overhead. Sending L1-RSRP measurements over higher layers would involve additional protocol processing, which could introduce delays and overhead. Therefore, L1 signaling is desired for reporting of small overhead with critical latency requirement, e.g. L1-RSRP measurements for inference.

In its turn, the other aspects of Life Cycle Management (LCM) of AI/ML models, including model training and functionality/model monitoring, might require individual consideration of the container and the layer in which the data is signaled.

In case of functionality/model monitoring at the NW-side, the NW may take an immediate action for model switching/fallback, or a long-term action, e.g., to retrain its model if the model performance is found not satisfactory. Obviously, the given decision of functionality/model monitoring comes with a different latency requirement.

The data collection for model training is performed seldom, is characterized by a relaxed latency requirement, but might come along with a larger payload size per UE report for beam management use case, since both measurements for Set A and Set B are needed.

Therefore, in embodiments of this invention it is propose the following: the network configures higher layers, e.g. layer 3, to signal the measurements performed on CSI-RS/SSB resources for AI/ML training/re-training scenarios due to their relaxed latency requirement. It would reduce the unnecessary overhead from the Uplink Control Information (UCI). Radio Resource Control (RRC) method at Layer 3 can be used as a container for data signaling in that case. In this case, the UE may be configured with a conventional L1 reporting procedure for a smaller number of beams, e.g. to perform inference, and a L3 CSI reporting procedure that reports for a larger (e.g. superset) set of beams.

For example, the CSI report config may include an information element (IE) “reportOnL3”, which causes the UE to report on L3 instead of UCI. In another example, the IE reportConfigType may take a value ‘periodicOnL3’ or ‘aperiodicOnL3’ or ‘semiPersistentOnL3’ to indicate how and where to report associated measurement data.

The following four alternatives for performance metrics for functionality/model monitoring of BM-Case1 and BM-Case2 were captured in the latest technical report (TR):
Alt.1: Beam prediction accuracy related KPIs, e.g., Top-K/1 beam prediction accuracy.
Alt.2: Link quality related KPIs, e.g., throughput, L1-RSRP, L1-SINR, hypothetical BLER.
Alt.3: Performance metric based on input/output data distribution of AI/ML.
Alt.4: The L1-RSRP difference evaluated by comparing measured RSRP and predicted RSRP

According to embodiments it is proposed to use a selective configuration of measurements reporting for performance monitoring purposes. The network might configure a UE for performance monitoring to perform measurements of Set A, e.g. Top-K beams, on layer 1 for immediate action, and in case of a long-term action reconfigure the UE to send measurement reports, e.g. all beams of Set A, on layer 3. So, the configuration might be performed selectively, depending on the purpose of the report, and be static for inference/training/re-training use cases and dynamic for functionality/model monitoring.

The network may configure UE to report L1-RSRP measurements for training/re-training/monitoring purposes within e.g. L3 RRC message: Measurement Report (MR). The legacy RRC MR might be extended for the given purpose to enable the required parameters of L1-RSRP measurements, including quantization, step sizes, etc.

Finally, the network may configure a UE also with a mix of reports. In this embodiment, the UE may in addition to the L1 KPI reportOnL3 also enhance the report using legacy L3-filtered values. The L3-filtered values can be used for normalizing feedback data and help to decide on one or more of:
Quantization steps and/or step size,
Quantization algorithm to use,
Frequency of sending feedback data.

### L1-Reporting of Averaging L1 Measurements

In another embodiment the UE might also perform averaging of L1 measurements (similar to L3 mobility use case) and signal them to the gNB to ensure stable AI/ML model's operation over time. This approach will reduce Layer 1 signaling overhead and might be used for performance monitoring at the NW-side.

### L3-Reporting of Predicted L1-RSRPs for AI/ML Mobility

In a new study on AI/ML for mobility in NR, the focus will be on enhancing the network triggered L3-based handover considering the AI/ML based radio resource management (RRM) and event prediction. In the legacy case, the UE provides L1-RSRP measurements of the neighboring cells, which are filtered at layer 3 to reduce noise fluctuations and remove outliers and reported in an RRC container. In that way, more reliable and consistent data can be used at the NW-side for the handover decision process.

However, in case AI/ML model or functionality is applied at the UE side, the inference results, i.e. predicted L1-RSRP values of the neighboring cells are already smoothed, i.e. do not include unnecessary noise fluctuations. Therefore, the given predicted L1-RSRPs might be used directly for L3 reporting without applying the filter function, which sequentially reduces the protocol processing delay.

### ASPECT 3

A third aspect 3 of the present invention concerns a UE that measures or predicts beams at different instances and has respective configurations indicating that the beams measured or predicted at the different instances belong to the same beams.

An embodiment of the present invention provides a user device, UE, for a wireless communication network, wherein the UE is to receive from a network entity of the wireless communication network a set of beams and to measure and/or predict a first number of the set of beams at a first instance and to measure and/or predict a second number of the set of beams at a second instance. Note, the UE is configured with a first configuration for measuring and/or predicting the first number of beams and with a second configuration for measuring and/or predicting the second number of beams, or wherein the UE is configured with a common configuration for measuring and/or predicting the first number of beams at a first instance and for measuring and/or predicting the second number of beams at a second instance, and wherein the first and second number of beams (more than two beams possible as well) are associated with the same set or subset of beams.

This aspect 3 may be used by the UE 302 of FIG. 3.

Specifically, embodiments of this aspect refer to multiple CSI-reporting associated with the same set config.

According to embodiments, configurations include indication that they are associated with the same set of beams are used. Thus, according to embodiments, the first and second configurations include an indication that the first and second numbers of beams are beams of the same set or subset of beams.

According to embodiments, the first and second configurations include an ID of or a reference to the same set or subset of beams and/or an ID of or reference to an AI/ML model or functionality (e.g. indication=ID or reference to beams/AI model). For example, the UE may be configured or preconfigured with a number of sets of beams, each having an ID. Then providing this set of beams ID in the first and second configurations provides the UE with the required information. In another example, the dataset ID may be used to indicate the set of beams. In a further example, the set of beams may be indicated using a model ID or functionality ID. The UE knows from this ID what the set of beams is, as every model or functional ID may be associated with a set of beams.

Due to the association of a CSI reporting with a set configuration and/or due to the carrier identification using an ID the analysis of the measurement results can be improved.

According to embodiments, the UE comprises a list indicating configurations that are associated with the same set or subset of beams (thus, UE may have list of configurations associated with the same set of beams).

According to embodiments, the UE comprises (ordered) prioritization information indicating an order of the first and second configurations. In other words embodiments refer to the prioritization of the report transmitted from the UE to the NW. For instance, an AI/ML model takes place at the UE, however performance monitoring is performed at the NW-side. The UE might provide L1-RSRP difference evaluated by comparing measured RSRP (e.g. Set A from first and second number of received beams) and predicted RSRPs back to the NW for performing a decision. However, since UE capability is limited in terms of a number of beams per one report, the beams for transmission should be split. The UE can be configured with the prioritization information, indicating which beams to report first.

According to embodiments, the prioritization information is based on one or more of the following:

-the strongest beams, e.g., based on one or more measured metrics, like RSRP, SINR, SNR, RI, PMI,
the best predicted beams,
the beams with a highest AI/ML confidence level,
the beams that consume the least processing power,
the beams indicated explicitly by the network,
the beams used by a neighboring UE, e.g., another UE within a certain minimum required communication range, MCR,
the beams used by another UE or network device with a same or similar quasi co-location, QCL,
the beams that the UE has been served before or beams that a different UE but located in a similar position was served, e.g., with a certain good performance.

According to embodiments, the UE is to create a report indicating the measured and/or predicted beams and
transmit the report, e.g., to a gNB using a UCI on a PUCCH or a PUSCH, or using a MAC CE or using L3 signaling, or
transmit the report, e.g., to a UE using a SCI on PSCCH or PSDCH, or using a PC5-RRC, or
not transmit the report and use the report only as an input to an AI/ML model or functionality of the UE, e.g. for inference, monitoring or training.

According to embodiments, the UE is to create the report by combining the measured and/or predicted first number of beams and the measured and/or predicted second number of beams, e.g., by using one or more of the following:
union,
set difference,
intersection,
symmetric difference,
cartesian product,
power set,
addition,
difference,
averaging,
multiplication,
division.

For example, the UE may use the union operation to join the two subsets to a single set. If data for the same beam is present in both subsets, the UE may combine the data for the same beam, e.g. by adding, averaging the data.

According to embodiments, the UE is
to measure and/or predict at least one further number of the set of beams at least one further instance, and
configured with at least one further configuration for measuring and/or predicting the at least one further number of beams, wherein the at least one further configuration includes an indication that the at least one further number of beams are beams of the set of beams, or
configured with a configuration containing at least one further number of beams or set of beams for measuring and/or predicting the further number of beams or set of beams at a further instance.

According to embodiments, the set of beams includes a Set A of beams describing an output space of an AI/ML model or functionality and/or a Set B of beams describing an input space of the AI/ML model or functionality (e.g. set of beams=Set A and/or Set B).

According to embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

An embodiment provides a wireless communication network, like a 3rd Generation Partnership Project, 3GPP, system, comprising one or more above user devices, UEs.

According to embodiments, one or more base stations, BSs, wherein the base station may comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, a satellite payload, e.g., a NTN gNB, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

Embodiments of aspect 3 of the present invention are now described in more detail with reference to the accompanying drawing. It is noted that the subsequently outlined and described aspects or embodiments may be combined such that some or all of the aspects/embodiments are implemented within one embodiment.

The capacity of a UE may be limited in terms of the number of beams it is able to report per beam report. This may be due to the limited computational power, memory, or other limitations of the hardware. In another scenario, the network may want to reduce the number of reference signals that it transmits per reporting occasion and hence, reduce the overall reference signal and reporting overhead. Especially, measuring the Set A of beams for training purposes requires many beams to be measured. In the state-of-the-art, the network may configure multiple CSI reporting configurations for different sets of reporting beams. However, especially in the case of UE-sided models, the UE would not be aware that different CSI reporting configurations are associated with the same Set A or Set B.

Note that Set A and Set B are terms to describe the output and input space of the AI/ML model or functionality, respectively. That means these sets may be explicitly or implicitly configured with the UE. For example, the UE may be configured with a Set A and/or Set B configuration defining the beams included in these sets. The given configuration of Set A/Set B maybe based on existing CSI framework, and be presented in the following existing Information Elements (IE) s (TS 38.331):
NZP-CSI-RS-Resource
NZP-CSI-RS-ResourceSet
CSI-ReportConfig
CSI-ResourceConfig

In another example, Set A and/or Set B may be derived from the output and/or input parameter space of a certain AI/ML model or functionality. In other words, the AI/ML model or functionality may have a certain range of the output and/or input parameters or it may have a certain number of output and/or input parameters, which define a certain Set A and/or Set B together with the association to the AI/ML model or functionality.

Hence, it is proposed that a UE may be configured with multiple CSI reports to the network that are associated with the same Set A or Set B. For example, the CSI report config may include an ID or reference to a Set A and/or Set B configuration. In another example, the CSI report may include an ID or reference to the AI/ML model or functionality. Thereby letting the UE know that the multiple CSI report configurations belong to a certain Set A and/or Set B. In a further example, a list may indicate the CSI report configs that are associated with the same Set A and/or Set B.

Moreover, the UE might be configured e.g. in CSI-ReportConfig with prioritization information, which might comprise the order of multiple CSI report configurations, in which the subset of Set A/Set B is transmitted. The given prioritization might be based on one or more of the following:
Top beams based on some measured metric, e.g. RSRP, SINR, SNR, RI, PMI,
Top predicted beams
Beams with the highest AI/ML confidence level
Beams that consume less processing power
Beams indicated explicitly by the network
Beams that a UE has been served before or beams that a different UE but located in a similar position was served, e.g., with a certain good performance. Note: location may be indicated by the UE or measured at the gNB or may be stored in the LMF with the CN. Furthermore, the location may be derived indirectly, e.g. from fingerprinting or from using neighborhood information from surrounding base stations, e.g., using data exchanged via XN interface.

The UE may transmit the report to the gNB using a UCI on PUCCH or PUSCH, using a MAC CE or using L3 signaling. However, the UE may also not transmit the report but instead use it only as an input to the AI/ML model or functionality as inference or as data for training. In a further embodiment, the UE may combine the measurement results from the multiple CSI report configs when passing to the AI/ML model or functionality. Here passing to the AI means performing inference or monitoring, i.e. use results as input, or performing training, i.e. use results as input and/or output. For example, the UE may combine a first subset of Set A/B and a second subset of Set A/B to a larger subset of Set A/B or the whole Set A/B. The combination may be performed using one or more of the following:
Union
Set difference
Intersection
Symmetric difference
Cartesian product
Power set
Addition
Difference
Averaging
Multiplication
Division.

### ASPECT 4

A fourth aspect/aspect 4 of the present invention concerns a UE performing measurements of performance parameters using CPUs according to a CPU occupation and/or handling one or more AI cores independently.

An embodiment provides a user device, UE, for a wireless communication network. The UE is to perform measurements of one or more performance parameters and to generate a measurement report, like a CSI report, for reporting the measurements. Further, the UE is to operate a plurality of measurement processing units (N_CPUs), like CSI processing units, wherein the measurement report is associated with a certain CPU occupation (O_CPU) indicating a number of measurement processing units (N_CPUs) operated simultaneously for generating the measurement report, and wherein the certain CPU occupation (O_CPU) is set to a number that depends on one or more criteria.

This fourth aspect may be used by the UE 302 as shown by FIG. 3.

A specific embodiment of this aspect refers to enhanced CSI processing criteria.

According to embodiments, the one or more criteria comprise on one or more of the following:
a number of measurements per measurement report, like the number of beams per measurement report,
a number of resources on which the UE is to perform the measurements, like the number of CSI-RS resources per CSI resource set,
a number of occupied measurement processing units to be used for a certain number of measurements, like beams, and/or a number of occupied measurement processing units required to run an Artificial Intelligence/Machine Learning, AI/ML, model or functionality for performing one or more tasks,
a complexity of an AI/ML model or functionality for performing one or more tasks,
a report type or purpose, e.g., inference, monitoring.
a configuration or pre-configuration.

According to embodiments, the certain occupancy is derived by taking the maximum required occupancy of all or some of the one or more criteria. According to further embodiments, the certain occupancy may be also derived by combining all or some of the one or more criteria, e.g. multiplication, addition.

According to embodiments, the certain CPU occupation (O_CPU) is set according to the number of occupied measurement processing units to be used for a certain number of measurements, like beams, and wherein the UE comprises a table defining an association between the number of measurements and the number of occupied measurement processing units, and the UE is to determine the number of measurements for the measurement report and select from the table the associated occupied measurement processing units (O_CPUs). For example, UE determines number of occupied CPUs from table associating measurements and CPUs to be used.

According to embodiments, the certain CPU occupation (O_CPU) is set according to the number of occupied measurement processing units to be used for a certain number of measurements, like beams, and the number of occupied measurement processing units required to run an Artificial Intelligence/Machine Learning, AI/ML, model or functionality for performing one or more tasks. E.g. UE determines number of occupied CPUs based on CPUs for measurement and CPUs for AI.

According to embodiments, the number of measurements per measurement report is associated with a first number of occupied measurement processing units (O_CPU,1) and the AI/ML model or functionality is associated with a second number of occupied measurement processing units (O_CPU,2), and a total number of occupied measurement processing units is determined by the sum of the first and second numbers (O_CPU, total=O_CPU,1 +O_CPU,2). E.g. UE determines number of occupied CPUs by the sum of CPUs for measurement and CPUs for AI.

According to embodiments, the certain CPU occupation (O_CPU) is set according to the complexity of an AI/ML model or functionality for performing one or more tasks, and wherein the certain CPU occupation (O_CPU) is determined using a predefined formula. For example, UE determines number of occupied CPUs from AI complexity.

According to embodiments, the predefined formula comprises one of the following formulas:
O_CPU=└N/C┘+B, where N is a complexity parameter, e.g. a number of measurements in the measurement report, like the number of beams in the CSI report, or a number of elementary operations associated with the task performed by the AI/ML model or functionality, or a number of resource sets, where C and B are constants, e.g. C=4 or C=8 and B=1 or B=0, and where └ . . . ┘ is the floor operation,
O_CPU=┌N/C┐+B, where N is a complexity parameter, e.g. a number of measurements in the measurement report, like the number of beams in the CSI report, or a number of elementary operations associated with the task performed by the AI/ML model or functionality, or a number of resource sets, where C and B are constants, e.g. C=4 or C=8 and B=1 or B=0, and where ┌ . . . ┐ is the ceiling operation,
O_CPU=N+B, where N is a complexity parameter, e.g. a number of measurements in the measurement report, like the number of beams in the CSI report, or a number of elementary operations associated with the task performed by the AI/ML model or functionality, or a number of resource sets, and where B is a constant, e.g. B=0 or B=1 or a number of resources.

According to embodiments, the UE comprises a plurality of Artificial Intelligence, AI, cores (e.g. GPU or TPU cores) for running one or more Artificial Intelligence/Machine Learning, AI/ML, models or functionalities for performing one or more tasks. E.g. UE includes AI cores.

According to embodiments, the UE is to use one or more of the AI cores for performing calculations associated with one or more measurement processing units. E.g. UE uses AI cores for measurement processing units.

According to embodiments, the UE is to report a number of AI cores (N_CPU,AI), e.g. using a UE capabilities report, which the UE comprises and/or a number of unoccupied AI cores. E.g. UE uses AI cores for measurement processing units.

According to embodiments, each AI/ML model or functionality is associated with a number of occupied AI cores (O_TPU), and wherein the number may be fixed, e.g. one, and may be the same for all AI/ML models or functionalities or different for each AI/ML model or functionality. E.g. UE uses AI cores for measurement processing units.

According to embodiments, the UE is to report, e.g., to a gNB using a UE capabilities report or using a semi-static indication, e.g. RRC, or using a dynamic indication, e.g. UCI, the number of currently occupied AI cores (O_TPU). Here, UE reports occupied AI cores. In another embodiment, the UE reports, e.g. to a gNB using a UE capabilities report, an occupation associated with an AI/ML functionality and/or AI/ML model and/or AI/ML feature/feature group. In a further embodiment, the occupation associated with an AI/ML functionality and/or AI/ML model and/or AI/ML feature/feature group is configured or preconfigured.

According to embodiments, the UE may perform measurements of performance parameters using CPUs according to a CPU occupation and handles AI core independently.

An embodiments provides a user device, UE, for a wireless communication network, wherein the UE is to perform measurements of one or more performance parameters, wherein the UE is to generate a measurement report, like a CSI report, for reporting the measurements, wherein the UE is to operate a plurality of measurement processing cores or measurement processing units (N_CPUs), like CSI processing units, wherein the measurement report is associated with a certain CPU occupation (O_CPU) indicating a number of measurement processing cores (N_CPUs) operated simultaneously for generating the measurement report, wherein the UE comprises a plurality of Artificial Intelligence, AI, cores or Artificial Intelligence/Machine Learning, AI/ML, processing units for running one or more AI/ML processes for performing one or more tasks on the measurements.

According to embodiments, if a number of occupied AI cores is such that there is an insufficient number of unoccupied AI cores for running a certain AI/ML process for performing one or more tasks on the measurements, the UE is to drop the certain AI/ML process; and/or wherein the UE is to report for the dropped AI/ML process alternative or unprocessed information (e.g. such as measurements or filtered measurements instead of any predictions).

According to embodiments, the alternative information includes one or more of the following:
one or more measurement results,
an indication that the AI/ML process was dropped,
one or more default values, e.g. zero,
one or more fallback predictions, e.g. a prediction performed using a fallback mechanism without using AI/ML.

According to embodiments, a duration of an occupation of an AI core is defined by a start and an end time.

According to embodiments, the start time comprises one or more of the following:
a start or an end of a certain symbol of an earliest, n-th, or latest resource of a set of resources to be measured, like CSI-RS resources to be measured for generating a CSI report,
a start or an end of a first symbol or a last symbol of a message, like a DCI or a PDCCH, triggering the report,
a certain time duration after the certain symbol of an earliest, n-th, or latest resource of a set of resources to be measured of after the first symbol or the last symbol of the message triggering the report.

According to embodiments, the end time comprises one or more of the following:
a start or an end of a first, n-th or last symbol of a transmission, like a PUCCH or a PUSCH, carrying the report or being associated with the report,
a start or an end of an earliest, n-th, or latest resource of a set of resources to be measured, like CSI-RS resources to be measured for generating a CSI report,
a certain time duration after the first, n-th or last symbol of the transmission carrying the report or being associated with the report, or after the earliest, n-th, or latest resource of the set of resources to be measured.

Note, UE may determine unoccupied AI cores as follows:

According to embodiments, an AI core occupation starts in a certain time slot, e.g. a certain OFDM symbol, and lasts until a certain time slot, e.g. a certain OFDM symbol, and wherein the UE is to determine a number of remaining unoccupied AI cores, which is smaller than or equal to a total number of AI cores.

According to embodiments, the UE is to determine the number of remaining unoccupied AI cores based on one or more of the following:
existing active occupations due to other AI/ML processes,
a reported occupancy,
internal limitations, e.g. hardware limitations, such as memory, CPU, etc.,
a battery level.

According to embodiments, the UE is to occupy one or more AI/ML cores if a model is to stay loaded in memory or has to be executed within a certain latency.

According to embodiments, the UE prioritizes AI cores as follows:

According to embodiments, if a total number of new AI core occupations occurring in a given time slot exceeds a predefined threshold, the UE is to prioritize AI/ML processes according to one or more certain criteria.

According to embodiments, the one or more certain criteria comprise one or more of the following:
a priority of the associated measurement report, like a CSI report,
a priority of the AI/ML functionality or model,
a priority of a transmission, like a PUCCH or PUSCH, carrying the measurement report or being associated with the measurement report,
a priority indicated in a message, like a DCI, triggering the measurement report,
a priority of an AI/ML feature or feature group.

According to embodiments, the UE comprising a processing unit including the plurality of measurement processing cores and the plurality of AI cores.

According to embodiments, the UE is to scale functions to run on measurement processing cores as well as on AI cores. I.e. UE scales functions.

According to embodiments, the UE is to switch off a part of the measurement processing cores and/or the AI cores due to processing constraints, e.g., a battery usage and/or a processing power. I.e. UE may switch off parts of the cores.

According to embodiments, the UE has a maximum of simultaneously running cores that include CPU as well as AI cores.

Th According to embodiments, the UE is to switch off one or more AI cores, e.g., in case a processing is too complex for the UE, and the UE is to shift the processing to a base station. E.g. UE switches off AI cores.

According to embodiments, the UE is to signal, e.g., to a gNB or to the network, a processing architecture of the UE, a usage of the processing architecture and capabilities of the UE for enabling the gNB or network to choose one or more adequate AI algorithms to be run at the gNB side and/or at the UE side. E.g. UE signal architecture

According to embodiments, the UE is to indicate, e.g., to the gNB, a processing state of the UE, depending on one or more criteria, e.g., a battery usage, another ongoing signal processing on at the UE, a moving speed of the UE. E.g. UE indicates processing state.

According to embodiments, the UE comprises a graphical processing unit, GPU, and wherein one or more or all of the AI cores are part of the GPU. I.e. UE may have GPU.

According to embodiments, the certain CPU occupation (O_CPU) is set to a number that depends on one or more criteria. E.g. UE performing measurements of performance parameters using CPUs according to a variable CPU occupation.

Performance values: According to embodiments, the one or more performance parameters comprise one or more of the following:
one or more beams, which are transmitted by a network entity of the wireless communication system and received at the UE, the performance value indicating a measured or predicted strength of a beam at the UE,
a reference signal received power, RSRP, the performance value indicating the measured or predicted RSRP,
a reference signal received quality, RSRQ, the performance value indicating the measured or predicted RSRQ,
a signal to noise ratio, SNR, the performance value indicating the measured or predicted SNR,
a rank,
a PMI,
a signal to noise and interference ratio, SINR, the performance value indicating the measured or predicted SINR,
a radio signal strength indicator RSSI, the performance value indicating the measured or predicted RSSI,
an interference level, the performance value indicating the measured or predicted interference level,
a doppler parameter, the performance value indicating the measured or predicted doppler parameter,
a delay, the performance value indicating the measured or predicted delay,
a packet loss rate, the performance value indicating the measured or predicted packet loss rate,
one or more parameters reported from higher layers, the performance value indicating the measured or predicted values for the one or more parameters.

According to embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

An embodiment provides a wireless communication network, like a 3rd Generation Partnership Project, 3GPP, system, comprising a one or more above user devices, UEs.

According to embodiments, the wireless communication network comprising one or more base stations, BSs, wherein the base station may comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, a satellite payload, e.g., a NTN gNB, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

Embodiments of aspect 4 of the present invention are now described in more detail with reference to the accompanying drawing. It is noted that the subsequently outlined and described aspects or embodiments may be combined such that some or all of the aspects/embodiments are implemented within one embodiment.

The current specification defines so-called CSI Processing Criteria for the generation of a CSI report, see 3GPP TS 38.214 V18.1.0 in section 5.2.1.6. In particular, the UE reports a number of CSI units (N_CPU) that are able to operate simultaneously. Then, each report type is associated with a certain CPU occupation. For example, reporting the SINR or RSRP occupies a single CPU (O_CPU=1). This way the UE may prioritize different CSI reports based on their associated priority. That means higher priority reports are processed first and lower priority ones are processed only if the number of CPUs is sufficient. However, this requirement may lead to issues in the context of AI/ML. In particular, the assumption of only a single CPU being occupied is justified for the current maximum number of reported beams of 4. However, it is discussed that the number of reported beams will be increased to, e.g., 128. This may require more processing power than is needed for four beams. Note, the number of supported beams does not need to be a multiple of 2, since there may also be cases were, e.g., 3 beams shall be supported, e.g., for lower cost NR systems which only have three active transmitter/receiver branches. Thus, for future NR systems, also uneven number of antenna branches, e.g., 47 transceivers, shall be supported. Also, the number of transceiver branches can also be larger than 128.

The occupation is schematically illustrated by FIG. 6. As can be seen before the reports are received R #1 and R #2 are used, wherein R #3 is used starting from the incoming reports. Dependent on the priority some resources can be dropped.

If the occupation of O_CPU=1 stays unchanged, the UE may have to report the number of available CPUs N_CPU is a much more conservative way, hence, causing a performance degradation.

In this idea, it is proposed that the occupation O_CPU is set to a variable number that depends on certain criteria. The number may depend on one or more of the following:
The number of beams per report
The number of CSI-RS resources per CSI resource set
An indication by the UE, e.g., the UE may indicate a number of occupied CPU for certain ranges of number of beams, and/or the number of occupied CPUs required to run the AI
The complexity of the AI/ML model or functionality, e.g. a certain AI/ML model or functionality may be associated with a certain number of occupied CPUs
The report type or purpose, e.g. for data collection, whether inference is performed or not

The parameters of the above list may also be used in combination. For example, the number of beams per report may be associated with a first number of occupied CPUs O_CPU,1 and the AI/ML model or functionality may be associated with a second number of occupied CPUs O_CPU,2. Then the total number of occupied CPUs may be determined by O_CPU,total=O_CPU,1+O_CPU,2.

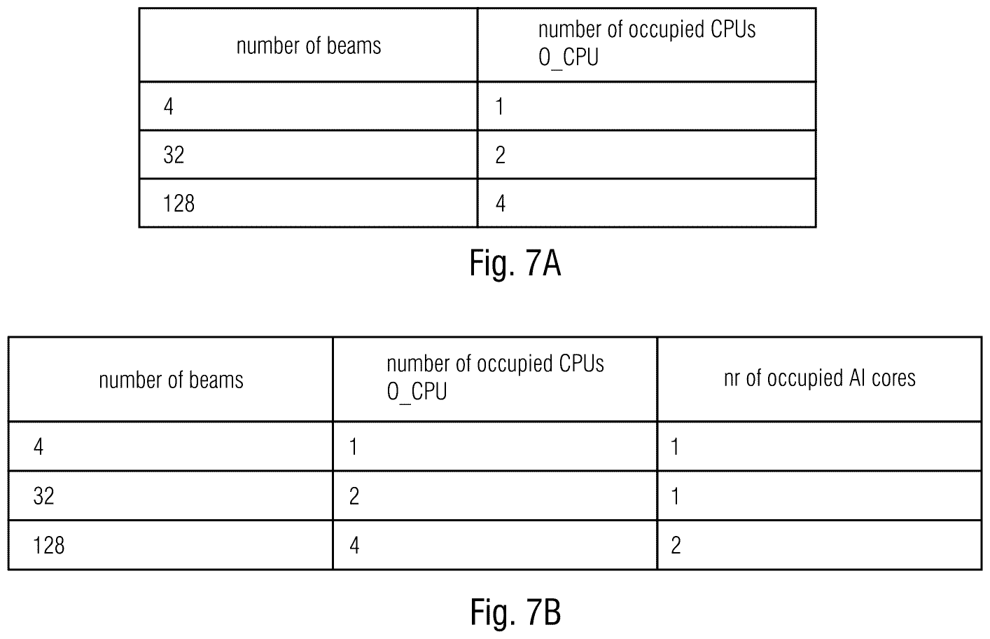

In FIG. 7a, an exemplary table is shown that defines an association between the number of beams and the number of occupied CPUs. In this example, the UE would first determine a number of beams for a report. Then, it would the row such that the first column is larger or equal to the determined number and the previous row is larger than the determined number. FIG. 7b enhances the association of FIG. 7a with respect to the number of occupied AI cores. This way, the second column in the picked row gives the number of occupied CPUs O_CPU.

In another example, the number of occupied cores differs depending on the type of core used.

This may be a preconfigured list/table or a fixed conversion, e.g. 1 AI core performs the calculations of 2 CPU cores.

In another example, the occupation may be determined by a formula: O_{CPU}=└N/C┘+B, where N is a complexity parameter, e.g. the number of beams in the CSI report or the number of elementary operations associated with the task or the number of resource sets, and C and B are constants, e.g. C=4 or C=8 and B=1 or B=0, and └ ┘ is the floor operation.

In a further example, the occupation may be determined by another formula: O_{CPU}=┌N/C┐+B, where N is a complexity parameter, e.g. the number of beams or the number of elementary operations or the number of resource sets, and C and B are constants, e.g. C=4 or C=8 and B=1 or B=0, and ┌ ┐ is the ceiling operation.

In another example, the occupation may be determined by another formula: O_{CPU}=N+B, where N is a complexity parameter, e.g. the number of beams or the number of elementary operations or the number of resource sets or the number of occupied processors for a specific task, and B is a constant, e.g. B=0 or B=1 or a number of resources.

Note that N may also be composed of multiple underlying parameters. For example, N=X*A, where X is a multiplier, e.g. the number of beams or number of component carriers or number of resource pairs, and A is a complexity associated with the processing, i.e. the number of processors occupied by pre-and post-processing and/or AI processing.

In another embodiment, the UE may additionally report a number of AI/ML processing units N_CPU,AI it has. Additionally or alternatively, the UE may also report the number of remaining unoccupied AI/ML processing units instead of the total number. Furthermore, each AI/ML model or functionality may be associated with a number of occupied AI/ML processing units O_TPU. For example, this number may be fixed, e.g. one, the same for all AI/ML models or functionalities or different for each. In another example, this may be indicated by the UE to the gNB, i.e. the UE reports in its UE capabilities report how many units a certain functionality or model occupies. Then, each report would occupy a certain number of AI/ML processing units. Based on this occupation the UE may prioritize the different CSI reports. For example, the occupation has to be such that it fulfills the CSI processing criteria as well as the AI/ML processing criteria. Nevertheless, the AI/ML processing criteria may not be applied to all CSI reports. For example, only reports that involve inference at the UE-side, i.e. the CSI report includes predicted data, would have to fulfill additionally the AI/ML processing criteria.

In another embodiment, the AI/ML processing criteria may be treated independently from the CSI processing criteria. For example, the UE may determine the CSI reports that are prioritized according to the CSI processing criteria and CSI report prioritization. Then, for an inference report, the UE may check whether sufficient AI/ML processing units are also available. In case enough are available, the UE proceeds as expected by applying the AI/ML to the measurement results and reporting the prediction in the CSI report. However, if some AI/ML processes cannot be run due to the occupancy and/or prioritization, the UE may report in the CSI report for the dropped AI/ML processes instead of the a subset or all predictions one or more of the following:
One or more measurement results,
An indication that the AI/ML process was dropped,

One or more default values, e.g. zero,
One or more fallback predictions, e.g. perform the prediction using a fallback mechanism without using AI/ML, i.e. report k strongest measured beams.

The duration of the occupation of AI/ML processing units may be defined by a start and an end time. The start time may be one or more of the following:
Start or end of a certain symbol of the earliest, n-th, or latest of a set of CSI-RS resources, e.g. CSI-RS for measurement, associated with the CSI report,
The start or end of a first or last symbol of a DCI or PDCCH triggering the CSI report,
After a certain time duration after the aforementioned reference points

The end time may be one or more of the following:
Start or end of a first, n-th or last symbol of a PUCCH or PUSCH carrying the report or is associated with the report,
Start or end of the earliest, n-th, or latest of a set of CSI-RS resources, e.g. CSI-RS for measurement, associated with the CSI report,
After a certain time duration after the aforementioned reference points.

When certain AI/ML occupations are supposed to start in a certain time slot, e.g. OFDM symbol, the UE determines a number of remaining unoccupied AI/ML processing units, which is smaller or equal to the total number of AI/ML processing units. The number of remaining unoccupied AI/ML processing units may be determined based on one or more of the following:
Already active occupations due to other AI/ML processes,
A reported occupancy,
Internal limitations, e.g. hard limitations, such as memory, CPU, etc.,
A battery level.

If the total number of new AI/ML processing unit occupations occurring in the given time slot, the UE prioritizes the AI/ML processes according to certain criteria. The criteria may be one or more of the following:
A priority of the associated CSI report,
A priority of the AI/ML functionality or model,
A priority of the PUCCH or PUSCH carrying the report or associated with the report,
A priority indicated in the DCI triggering the CSI report,
A priority of the AI/ML feature or feature group.

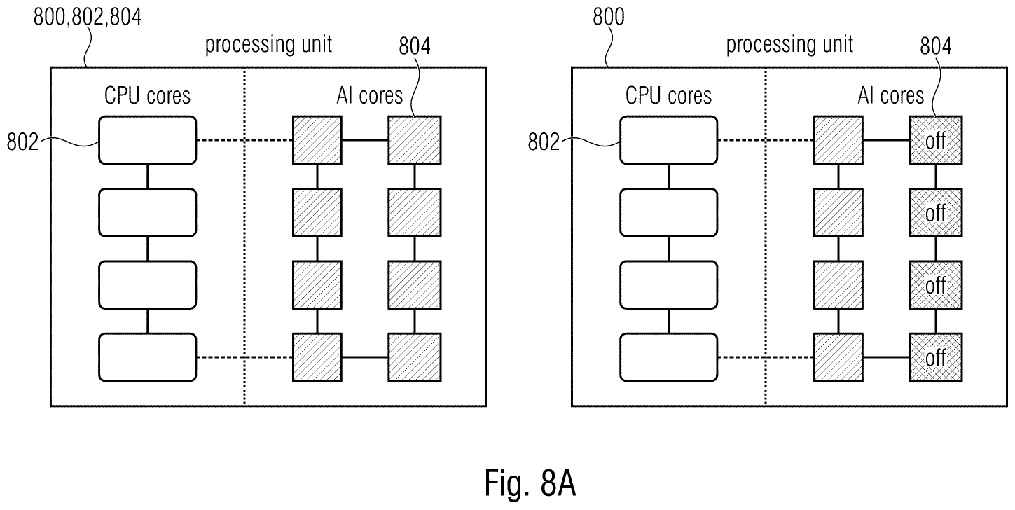

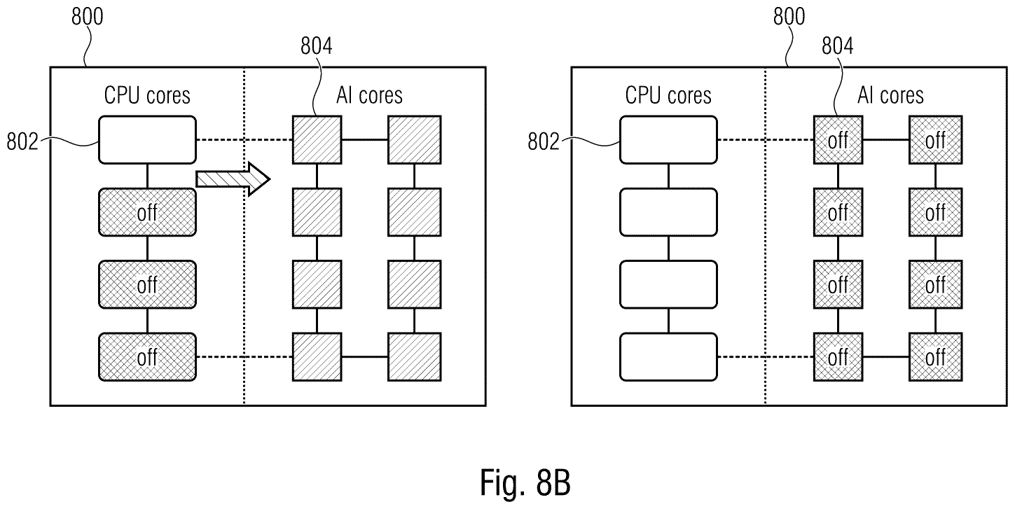

Possible architectures of the processing unit are depictured in FIGS. 8a and 8b. The processing unit 800 may consist of one or more CPU cores 802, as well as one or more AI cores 804. Functions can be scaled to run on CPU 802 as well as AI cores 804. FIG. 8a shows the processing unit 800 have a plurality of CPU cores 802 and a plurality of AI cores 804. As it is illustrated by FIG. 8a (left side) all AI cores 804 can be used assigned to the CPU cores 802. Furthermore, part of the CPU 802 and/or AI cores 804 may be switched off, due to processing constraints, e.g., battery usage and/or processing power. This is illustrated by the right side of FIG. 8a, where some AI cores 804 are switched off. Furthermore, it may make sense to perform load balancing and depending on the amount of AI processing going on, shift more processing to the AI cores 804, or alternatively, shift more processing to the CPU cores 802. As illustrated with FIG. 8b left side, some CPU cores 802 may be switched off.

In addition, it may be required to switch off AI cores 804, e.g., in case the processing is too complex for a said UE, and shift processing to the base station. FIG. 8 illustrates this on the right side, where all AI cores 804 are switched off. A particular processing architecture, usage and capabilities may be signalled to the gNB and/or network, in order to enable the gNB to choose adequate AI algorithms to be run at gNB and/or UE side. Finally, the system may be very dynamic, such that a UE may indicate to the gNB its processing state, depending on one or more criteria, e.g., battery usage, other signal processing going on at the UE, moving speed of the UE, etc. Note, AI cores 804 can also be part of a graphical processing unit, GPU.

### ASPECT 5

A fifth aspect of the present invention concerns the selection of CSI reporting enhancement dependent on criteria.

An embodiment provides a user device, UE, for a wireless communication network, wherein the UE is to perform measurements of one or more performance parameters for at least two beams. Here, the UE is to report the measurements using a signaling according to at least two reporting modes; wherein the at least two reporting mode differ from each other with respect to a transmitted information within a report; wherein the UE is to select the reporting mode dependent on one or more criteria.

Specifically, embodiments are in the field of CSI reporting enhancements

According to embodiments, the one or more criteria are out the group comprising:
number of beams;
number of beams per report;
number of reported beams;
required or configured accuracy;
configuration or indication or configuration from the gNB;
available report size;
number of beams per CSI resource set;
number of beams per CSI report configuration;
device type;
one or more internal conditions of the UE;
calculated report size.

According to embodiments, the above discussed principles of the fifth aspect may be used by the UE 302 of FIG. 3.

According to embodiments, the UE is to calculate the report size or to calculate the report sizes using one or more of the following formulas:

$$\begin{matrix}{R}_{diff} = A + D \times ( min ( N , {N}_{max} ) - 1 ) + ( min ( N , {N}_{max} ) - 1 ) \times C \\ {R}_{CriLess} = A \times N \\ {R}_{SingleCri} = A + C + D \times ( N - 1 ) .\end{matrix}$$

According to embodiments, the UE is to select the reporting mode such that the report size is minimized. The dependency of the reporting mode from one or more criteria helps reduce the report size. The reduced report size minimizes the reporting overhead when exchanging the reports.

Modes as illustrated by plot report size/number of beams:

According to embodiments, the at least two reporting modes are out of a group comprising:
a first reporting mode;
a second reporting mode; and
third reporting mode.

According to embodiments, at least one of the at least two reporting modes comprises more directly referenced identification information of the at least two beams when compared to the remaining of the at least two reporting modes.

According to embodiments, at least one of the at least two reporting modes comprises more absolute measurement information for the measurements of the at least two beams when compared to the remaining of the at least two reporting modes.

According to embodiments, at least one of the at least two reporting modes comprises directly referenced identification information for all of the at least two beams.

According to embodiments, a at least one of the at least two reporting modes comprises directly referenced identification information for none of the at least two beams.

According to embodiments, at least one of the at least two reporting modes comprises directly referenced identification information for none of the at least two beams, and wherein the at least one reporting mode comprises absolute measurement information for all of the at least two beams.

According to embodiments, at least one of the at least two reporting modes comprises directly referenced identification information for just one of the at least two beams or of the strongest of the at least two beams.

According to embodiments, at least one of the at least two reporting modes comprises absolute measurement information for just one of the at least two beams, namely of one of the at least two beams or of the strongest of the at least two beams; and/or wherein at least one reporting mode comprises absolute measurement information for just one of the at least two beams, namely of one of the at least two beams or of the strongest of the at least two beams and differential measurement information for the remaining of the at least two beams, namely for other of the at least two beams

According to embodiments, at least one of the at least two reporting modes comprises directly referenced identification information for none of the at least two beams.

According to embodiments, at least one of the at least two reporting modes comprises absolute measurement information for all of the at least two beams.

Note all of the above described reporting modes may be combined, so that two or even more reporting modes are supported by the UE.

According to embodiments, the at least two reporting modes differ in terms of at least one of one or more of the following:
directly referenced identification information, e.g. whether to omit all or part of beam indices, e.g. CRI, beam ID, SSBRI, index position in a list (e.g. CSI-RS resource set);
order of measurement information, e.g. ordered by strength, ordered by natural order, ordered by configuration or list order, partially ordered, etc.;
measurement information, e.g. whether the absolute measurement information or a differential measurement information is used to represent the beam;
Absolute RSRP with CRI, e.g., the strongest or top K beams with their corresponding RSRP and CRI to eliminate the quantization error.

According to embodiments, one report is sent for each group of measurements and/or assigned to reference signal (CSI-RS) resource indices.

According to embodiments, each of the one or more performance parameters comprise one or more performance parameter values, wherein the one or more performance parameter values comprise one or more of the following:
one or more beams, which are transmitted by a network entity of the wireless communication system and received at the UE, the performance value indicating a measured or predicted strength of a beam at the UE,
a reference signal received power, RSRP, the performance value indicating the measured or predicted RSRP,
a reference signal received quality, RSRQ, the performance value indicating the measured or predicted RSRQ,
a signal to noise ratio, SNR, the performance value indicating the measured or predicted SNR,
a rank,
a PMI,
a signal to noise and interference ratio, SINR, the performance value indicating the measured or predicted SINR,
a radio signal strength indicator RSSI, the performance value indicating the measured or predicted RSSI,
an interference level, the performance value indicating the measured or predicted interference level,
a doppler parameter, the performance value indicating the measured or predicted doppler parameter,
a delay, the performance value indicating the measured or predicted delay,
a packet loss rate, the performance value indicating the measured or predicted packet loss rate,
one or more parameters reported from higher layers, the performance value indicating the measured or predicted values for the one or more parameters.

According to embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

An embodiment provides a gNB of a wireless communication network, wherein the gNB is to receive a measurement report on measurements of one or more performance parameters for at least two beams performed by the UE; wherein the UE is to report the measurements using a signaling according to at least two reporting modes; wherein the at least two reporting mode differ from each other with respect to the transmitted information; wherein the gNB defines criteria for selecting the reporting modes.

An embodiment provides a wireless communication network, like a 3_{rd} Generation Partnership Project, 3GPP, system, comprising a one or more above user devices, UEs.

Another embodiment provides a user device, UE, for a wireless communication network, wherein the UE is to perform measurements of one or more performance parameters for at least two beams, wherein the UE is to report the measurements using a signaling according to at least one reporting mode; here, the reporting mode defines a report comprising absolute measurement information for at least one beam of the at least two beams, namely of at least one of the at least two beams or of the strongest of the at least two beams, and differential measurement information for one or more beams belonging to at least one other beam of the at least two beams; the report comprises directly referenced identification information for the at least one beam of the at least two beams or for the strongest of the at least two beams. In other words this means, that reporting using “natural order” can be supported

According to embodiments, the report comprises none directly referenced identification information of the other beams of the at least two beams.

According to embodiments, wherein the report comprises differential measurement information for the one or more beams belonging to at least two other beam of the at least two beams.

According to embodiments, wherein the report has an order for the absolute measurement information and/or differential measurement information.

According to embodiments, wherein order is defined dependent on a geometric relationship of the at least two beams.

According to embodiments, wherein order is predefined or preconfigured or configured.

According to embodiments, wherein the order is a natural order according to reference signal (CSI-RS) resource index or described how the beams or their associated reference signals (CSI-RS) are configured or transmitted (e.g. SSBs).

According to embodiments, wherein absolute measurement information and differential measurement information comprise quantized RSRPs; and/or wherein referenced identification information comprise CRI or SSBRI.

According to embodiments, wherein the reporting mode uses a report as defined by one or more of the following rules:
Omit all or part of beam indices, e.g. CRI, beam ID, SSBRI, index position in a list (e.g. CSI-RS resource set);
Order of beams, e.g. ordered by strength, ordered by natural order, partially ordered, etc.;
Value type, e.g. whether the absolute RSRP or a differential RSRP is used to represent the beam;
Absolute RSRP with CRI, e.g., the strongest or top K beams with their corresponding RSRP and CRI to eliminate the quantization error.

According to embodiments, wherein the reporting mode is referred to as third reporting mode selectable among a first and/or second reporting mode.

According to embodiments, each of the one or more performance parameters comprise one or more performance parameter values, wherein one or more performance parameter values comprise one or more of the following:
one or more beams, which are transmitted by a network entity of the wireless communication system and received at the UE, the performance value indicating a measured or predicted strength of a beam at the UE,
a reference signal received power, RSRP, the performance value indicating the measured or predicted RSRP,
a reference signal received quality, RSRQ, the performance value indicating the measured or predicted RSRQ,
a signal to noise ratio, SNR, the performance value indicating the measured or predicted SNR,
a rank,
a PMI,
a signal to noise and interference ratio, SINR, the performance value indicating the measured or predicted SINR,
a radio signal strength indicator RSSI, the performance value indicating the measured or predicted RSSI,
an interference level, the performance value indicating the measured or predicted interference level,
a doppler parameter, the performance value indicating the measured or predicted doppler parameter,
a delay, the performance value indicating the measured or predicted delay,
a packet loss rate, the performance value indicating the measured or predicted packet loss rate,
one or more parameters reported from higher layers, the performance value indicating the measured or predicted values for the one or more parameters.

According to embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IOT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

An embodiment provides a gNB of a wireless communication network, wherein the gNB is to receive a report on measurements of one or more performance parameters for at least two beams from a UE using a signaling according to at least one reporting mode; here, the reporting mode defines a report comprising absolute measurement information for at least one beam of the at least two beams, namely of at least one of the at least two beams or of the strongest of the at least two beams, and differential measurement information for one or more beams belonging to at least one other beam of the at least two beams; the report comprises directly referenced identification information for the at least one beam of the at least two beams or for the strongest of the at least two beams; wherein the gNB is to calculate an absolute measurement information for the least one other beam using the absolute measurement information, differential measurement information and an order for the absolute measurement information and/or differential measurement information.

An embodiment provides a wireless communication network, like a 3^{rd} Generation Partnership Project, 3GPP, system, comprising a one or more above user devices, UEs.

Embodiments of aspect 5 the present invention are now described in more detail with reference to the accompanying drawing. It is noted that the subsequently outlined and described aspects or embodiments may be combined such that some or all of the aspects/embodiments are implemented within one embodiment.

In the current state-of-the-art, the UE reports the quantized absolute and differential RSRPs together with the CRI or SSBRI. The CSI-RS resource index, CRI, or SSB resource index, SSBRI, are identifiers that identify the beam. This is required because the UE usually reports only the k-strongest beams but not all measured beams. Now it is discussed that the UE reports all beams in their natural ordering (not ordered based on their strength) and omits the CRI or SSBRI completely. However, then the differential RSRPs cannot be used anymore because they are defined relative to the strongest beam. But the strongest beam is not necessarily the first one. Hence, the UE then has to quantize the absolute RSRPs for each beam. This increases the overhead because an absolute RSRP is quantized using 7 bits but a differential RSRP is quantized using only 4 bits.

In our embodiment, it is proposed that the UE reports as the first beam the strongest beam as an absolute RSRP together with its CRI or SSBRI. However, for the remaining beams the UE reports the differential RSRP with respect to the strongest beam without their CRIs or SSBRIs. Instead, it simply uses their natural ordering, e.g. according to their CSI-RS resource index or their order of configuration or their order in a list. Since, the gNB now knows which beam is the strongest (due to the CRI, SBBRI of the first beam) and furthermore knows the natural order, it can reconstruct the RSRPs for all beams when it receives the report from the UE.

Natural order describes the order of how the beams or their associated reference signals (CSI-RS) are configured or transmitted (e.g. SSBs).

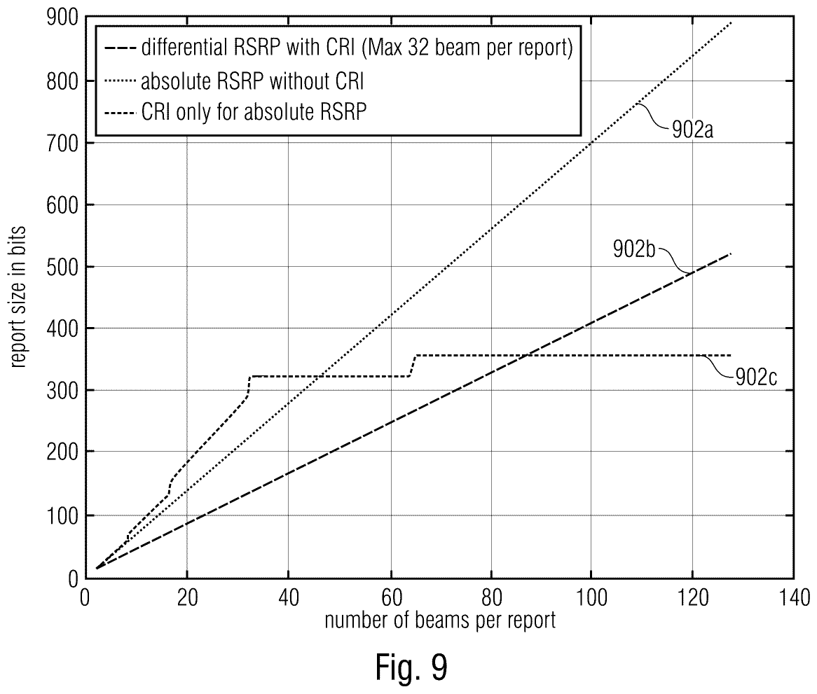

FIG. 9 shows the report size plotted over the number of reports for three different report modes 902a, 902b and 902c.

In the plot, we show the resulting report size of 3 report construction strategies:
Differential RSRP with CRI (Max 32 beam per report, SOTA-902c)
Absolute RSRPs without CRI (SOTA-902a)
CRI only for first beam (1^{st} embodiment-902b)

We observe that each of the schemes have their advantages and disadvantages depending on the number of beams per report. In particular, the absolute RSRP strategy (902a) may seem inferior to the CRI only for the absolute RSRP (902b), however the absolute RSRP strategy has a more accurate quantization compared to the other one. Hence, it allows more accurate reporting.

In another embodiment, it is proposed that the UE changes the report construction rules based on certain criteria.

The report construction rules may comprise one or more of the following:
Omit all or part of beam indices, e.g. CRI, beam ID, SSBRI, index position in a list (e.g. CSI-RS resource set)
Order of beams, e.g. ordered by strength, ordered by natural order, partially ordered, etc.
Value type, e.g. whether the absolute RSRP or a differential RSRP is used to represent the beam
Absolute RSRP with CRI, e.g., the strongest or top K beams with their corresponding RSRP and CRI to eliminate the quantization error.

The criteria may be one or more of the following:
Number of beams per CSI resource set
Number of beams per CSI report configuration
Number of reported beams
An indication or configuration from the gNB
A device type.
one or more internal conditions of the UE.

The criteria may also be defined using a formula. For example, the report size may be determined as:

$$\begin{matrix}{R}_{diff} = A + D \times ( min ( N , {N}_{max} ) - 1 ) + ( min ( N , {N}_{max} ) - 1 ) \times C ( blue ) \\ {R}_{CriLess} = A \times N ( red ) \\ {R}_{SingleCri} = A + C + D \times ( N - 1 ) ( yellow )\end{matrix}$$

Where A is the quantization bit size of an absolute RSRP, D is the quantization bit size of a differential RSRP, N is the number of beams in the report configuration, e.g. CSI-RS resource set or CSI report config, N_max is the maximum number of reported beams, C is the bit size of the CRI (C=┌log₂ N┐). Using these formula, the UE may determine the resulting report sizes of a set of different report construction rules and choose the report construction rule that minimizes the report size out of the set of report construction rules.

### Methods

The above embodiments of all aspects may be implemented as apparatus, e.g., network entities like UEs or also implemented as methods.

Thus, embodiments of the present invention provide a method for operating a user device, UE, for a wireless communication network, comprising:
determining for a performance parameter a plurality of performance values using
   a measurement of one or more reference signal resources, and/or
   at least one Artificial Intelligence/Machine Learning, AI/ML, model or functionality,
quantizing and reporting at least one of the plurality of performance values as an absolute value and one or some of the plurality of performance values as differential values, wherein a differential value is computed with reference to or relative to one of the plurality of performance values, wherein the UE is configured or preconfigured with two or more different quantization parameter sets, each quantization parameter (quantization parameter set may contain information on both the absolute quant and the differential quant parameters) set including one or more quantization parameters for quantizing the absolute values and/or the differential values, and
applying at least one of the quantization parameter sets for quantizing the absolute values and/or the differential values.

Further embodiments provide a method for operating a user device a user device, UE, for a wireless communication network, comprising:
receiving from a network entity of the wireless communication network a set of beams,
measuring and/or predicting a first number of the set of beams at a first instance and to measure and/or predict a second number of the set of beams at a second instance, wherein the UE is configured with a first configuration for measuring and/or predicting the first number of beams and with a second configuration for measuring and/or predicting the second number of beams, or wherein the UE is configured with a common configuration for measuring and/or predicting the first number of beams at a first instance and for measuring and/or predicting the second number of beams at a second instance, and wherein the first and second or another number of beams are associated with the same set or subset of beams.

Further embodiments provide a method for operating a user device, UE, for a wireless communication network, comprising:
performing measurements of one or more performance parameters,
reporting the measurements using a signaling according to
   a first layer of a wireless communication network protocol stack, or
   a second layer of the wireless communication network protocol stack, the second layer, e.g. Layer 3, L3, being higher than the first layer, e.g., Layer 1, L1,
wherein the UE is to select the signaling dependent on one or more criteria.

Further embodiments provide a method for operating a user device, UE, for a wireless communication network, comprising:
performing measurements of one or more performance parameters,
generating a measurement report, like a CSI report, for reporting the measurements,
operating a plurality of measurement processing units (N_CPUs), like CSI processing units, wherein the measurement report is associated with a certain CPU occupation (O_CPU) indicating a number of measurement processing units (N_CPUs) operated simultaneously for generating the measurement report, and wherein the certain CPU occupation (O_CPU) is set to a number that depends on one or more criteria.

Further embodiments provide a method for operating a user device, UE, for a wireless communication network, comprising:
performing measurements of one or more performance parameters,
generating a measurement report, like a CSI report, for reporting the measurements,
operating a plurality of measurement processing cores or measurement processing units (N_CPUs), like CSI processing units, wherein the measurement report is associated with a certain CPU occupation (O_CPU) indicating a number of measurement processing cores (N_CPUs) operated simultaneously for generating the measurement report,
having access to a plurality of Artificial Intelligence, AI, cores or Artificial Intelligence/Machine Learning, AI/ML, processing units for running one or more AI/ML processes for performing one or more tasks on the measurements.

Further embodiments provide a method for operating a user device, UE, for a wireless communication network,
performing measurements of one or more performance parameters for at least two beams,
reporting the measurements using a signaling according to at least two reporting modes;
   wherein the at least two reporting mode differ from each other with respect to the transmitted information; wherein the UE is to select the first or second signaling dependent on one or more criteria.

Further embodiments provide a method for operating a gNB of a wireless communication network, comprising the steps
receiving a measurement report on measurements of one or more performance parameters for at least two beams performed by the UE; wherein the UE is to report the measurements using a signaling according to at least two reporting modes; wherein the at least two reporting mode differ from each other with respect to the transmitted information;
defining criteria for selecting the reporting modes.

Further embodiments provide a method for operating a user device, UE, for a wireless communication network, comprising:
performing measurements of one or more performance parameters for at least two beams,
reporting the measurements using a signaling according to at least one reporting mode;
   here, the reporting mode defines a report comprising absolute measurement information for at least one beam of the at least two beams, namely of at least one of the at least two beams or of the strongest of the at least two beams, and differential measurement information for one or more beams belonging to at least one other beam of the at least two beams; note, the report comprises directly referenced identification information for the at least one beam of the at least two beams or for the strongest of the at least two beams.

Further embodiments provide a method for operating a gNB of a wireless communication network, comprising:
receiving a report on measurements of one or more performance parameters for at least two beams from a UE using a signaling according to at least one reporting mode; wherein the reporting mode defines a report comprising absolute measurement information for at least one beam of the at least two beams, namely of at least one of the at least two beams or of the strongest of the at least two beams, and differential measurement information for one or more beams belonging to at least one other beam of the at least two beams; the report comprises directly referenced identification information for the at least one beam of the at least two beams or for the strongest of the at least two beams;
calculating an absolute measurement information for the least one other beam using the absolute measurement information, differential measurement information and an order for the absolute measurement information and/or differential measurement information.

### General

Embodiments of the present invention have been described in detail above, and the respective embodiments and aspects may be implemented individually or two or more of the embodiments or aspects may be implemented in combination.

In accordance with embodiments, the wireless communication system may include a terrestrial network, or a non-terrestrial network, or networks or segments of networks using as a receiver an airborne vehicle or a space-borne vehicle, or a combination thereof. Further, the wireless communication system may by a system or network different from the above described 4G or 5G mobile communication systems, rather, embodiments of the inventive approach may also be implemented in any other wireless communication network, e.g., in a private network, such as an Intranet or any other type of campus networks, or in a WiFi communication system.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or a Wi-Fi device, like a station (STA), access point (AP), node or mesh node, or mesh point, or Mesh AP, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a Wi-Fi device such as an access point (AP) or mesh node (Mesh AP), or a remote radio head, or an AMF, or a MME, or a SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear, that these aspects also represent a description of the corresponding method, where a block or a device corresponds to a method step or a feature of a method step. Analogously, aspects described in the context of a method step also represent a description of a corresponding block or item or feature of a corresponding apparatus.

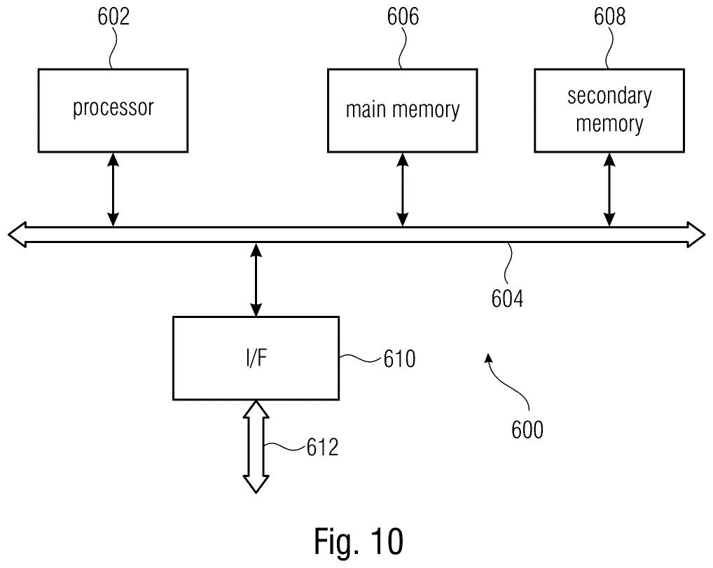

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 10 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication network,
wherein the UE is to perform prediction of one or more performance parameters,
wherein the UE is to generate a prediction report, like a CSI report, for reporting the predictions,
wherein the UE is to operate a plurality of processing cores or processing units (N_CPUs), like CSI processing units, wherein the prediction report is associated with a certain CPU occupation (O_CPU) indicating a number of processing units (N_CPUs) operated simultaneously for generating the prediction report,
wherein the UE comprises a plurality of processing units, like Artificial Intelligence, AI, cores or Artificial Intelligence/Machine Learning, AI/ML, processing units for running one or more processes, like AI/ML processes for performing one or more tasks on the predictions.

2. A user device, UE of claim 1, wherein, if a number of occupied second processing units, like AI processing units is such that there is an insufficient number of unoccupied AI processing units for running a certain AI/ML process for performing one or more tasks on the predictions, the UE is to report for the AI/ML process alternative or unprocessed information (e.g. such as predictions or filtered predictions).

3. The user device, UE, of claim 1, wherein the alternative information comprises one or more of the following:
one or more prediction results,
an indication that the AI/ML process was dropped,
one or more default values, e.g. zero,
one or more fallback predictions, e.g. a prediction performed using a fallback mechanism without using AI/ML.

4. The user device, UE, of claim 1, wherein a duration of an occupation of an AI processing unit is defined by a start and an end time.

5. The user device, UE, of claim 4, wherein the start time comprises one or more of the following:
a start or an end of a certain symbol of an earliest, n-th, or latest resource of a set of resources to be measured, like CSI-RS resources to be measured for generating a CSI report,
a start or an end of a first symbol or a last symbol of a message, like a DCI or a PDCCH, triggering the report,
a certain time duration after the certain symbol of an earliest, n-th, or latest resource of a set of resources to be measured of after the first symbol or the last symbol of the message triggering the report.

6. The user device, UE, of claim 4, wherein the end time comprises one or more of the following:
a start or an end of a first, n-th or last symbol of a transmission, like a PUCCH or a PUSCH, carrying the report or being associated with the report,
a start or an end of an earliest, n-th, or latest resource of a set of resources to be measured, like CSI-RS resources to be measured for generating a CSI report,
a certain time duration after the first, n-th or last symbol of the transmission carrying the report or being associated with the report, or after the earliest, n-th, or latest resource of the set of resources to be measured.

7. The user device, UE, of claim 1, wherein an AI processing unit occupation starts in a certain time slot, e.g. a certain OFDM symbol, and wherein the UE is to determine a number of remaining unoccupied AI processing units, which is smaller than or equal to a total number of AI processing units.

8. The user device, UE, of claim 7, wherein the UE is to determine the number of remaining unoccupied AI processing units based on one or more of the following:
existing active occupations due to other AI/ML processes,
a reported occupancy,
internal limitations, e.g. hardware limitations, such as memory, CPU, etc.,
a battery level.

9. The user device of claim 1, wherein the UE is to occupy one or more AI/ML processing units if a model is to stay loaded in memory or has to be executed within a certain latency.

10. The user device, UE, of claim 1, wherein, if a total number of processing unit occupations, like AI processing unit occupations, of the processing units occurring in a given time slot exceeds a predefined threshold, the UE is to prioritize AI/ML processes according to one or more certain criteria.

11. The user device, UE, of claim 10, wherein the one or more certain criteria comprise one or more of the following:
a priority of the associated prediction report, like a CSI report,
a priority of the AI/ML functionality or model,
a priority of a transmission, like a PUCCH or PUSCH, carrying the prediction report or being associated with the prediction report,
a priority indicated in a message, like a DCI, triggering the prediction report,
a priority of an AI/ML feature or feature group.

12. The user device, UE, of claim 1, comprising a processing unit comprising the plurality of processing cores or the plurality of AI cores.

13. The user device, UE, of claim 12, wherein the UE is to scale functions to run on processing cores as well as on AI cores.

14. The user device, UE, of claim 12, wherein the UE is to switch off a part of the processing cores and/or the AI cores due to processing constraints, e.g., a battery usage and/or a processing power.

15. The user device UE of claim 1, wherein the UE comprises a maximum of simultaneously running processing units that comprise CPU as well as AI processing units.

16. The user device, UE, of claim 12, wherein the UE is to switch off one or more AI processing units, e.g., in case a processing is too complex for the UE, and the UE is to shift the processing to a base station.

17. The user device, UE, of claim 12, wherein the UE is to signal, e.g., to a gNB or to the network, a processing architecture of the UE, a usage of the processing architecture and capabilities of the UE for enabling the gNB or network to choose one or more adequate AI algorithms to be run at the gNB side and/or at the UE side.

18. The user device, UE, of claim 1, wherein each AI/ML process or report is associated with a number of occupied AI process units (O_CPU, AI).

19. The user device, UE, of claim 1, wherein the UE is to report, e.g., to a gNB using a UE capabilities report, the number of processing units, like AI processing units, being occupied (O_TPU, AI).

20. The user device, UE, of claim 1, wherein the report has to fulfill the CSI processing criteria and the AI/ML processing criteria.

21. The user device, UE, of claim 1, wherein the UE is to indicate, e.g., to the gNB, a processing state of the UE, depending on one or more criteria, e.g., a battery usage, another ongoing signal processing on at the UE, a moving speed of the UE.

22. The user device, UE, of claim 1, wherein the UE comprises a graphical processing unit, GPU, and wherein one or more or all of the AI processing units are part of the GPU.

23. The user device, UE, of claim 1, wherein the certain CPU occupation (O_CPU) is set to a number that depends on one or more criteria.

24. The user device, UE, of claim 1, wherein the one or more performance parameters comprise one or more of the following:
one or more beams, which are transmitted by a network entity of the wireless communication system and received at the UE, the performance value indicating a measured or predicted strength of a beam at the UE,
a reference signal received power, RSRP, the performance value indicating the measured or predicted RSRP,
a reference signal received quality, RSRQ, the performance value indicating the measured or predicted RSRQ,
a signal to noise ratio, SNR, the performance value indicating the measured or predicted SNR,
a rank,
a PMI,
a signal to noise and interference ratio, SINR, the performance value indicating the measured or predicted SINR,
a radio signal strength indicator RSSI, the performance value indicating the measured or predicted RSSI,
an interference level, the performance value indicating the measured or predicted interference level,
a doppler parameter, the performance value indicating the measured or predicted doppler parameter,
a delay, the performance value indicating the measured or predicted delay,
a packet loss rate, the performance value indicating the measured or predicted packet loss rate,
one or more parameters reported from higher layers, the performance value indicating the measured or predicted values for the one or more parameters.

25. The user device, UE, of claim 1, wherein a beam ID comprises one out of the following:
TCI state
TCI index
CSI-RS index, or CRI
SSB index, or SSBRI, or SBB ID
DMRS index
SRS index.

26. The user device, UE, of claim 1, wherein the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE or Ambient IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, an industrial IoT-UE, IIoT, or a SL UE, or a vehicular UE, or a vehicular group leader UE, GL-UE, or a scheduling UE, S-UE, or an IoT or narrowband IoT, NB-IoT, device, a NTN UE, or a WiFi device or WiFi station, STA, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

27. A wireless communication network, like a 3^{rd} Generation Partnership Project, 3GPP, system, comprising a one or more user devices, UEs, of claim 1.

28. The wireless communication network of claim 27, comprising one or more base stations, BSs, wherein the base station may comprises one or more of a macro cell base station, or a small cell base station, or a central unit of a base station, or a distributed unit of a base station, or an Integrated Access and Backhaul, IAB, node, or a road side unit, RSU, or a WiFi access point, AP, or a UE, or a SL UE, or a group leader UE, GL-UE, or a relay or a remote radio head, a satellite payload, e.g., a NTN gNB, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

29. Method for operating a user device, UE, for a wireless communication network, comprising:
performing prediction of one or more performance parameters,
generating a prediction report, like a CSI report, for reporting the predictions,
operating a plurality of processing cores or processing units (N_CPUs), like CSI processing units, wherein the prediction report is associated with a certain CPU occupation (O_CPU) indicating a number of processing units (N_CPUs) operated simultaneously for generating the prediction report,
having access to a plurality of Artificial Intelligence, AI, cores or Artificial Intelligence/Machine Learning, AI/ML, processing units for running one or more AI/ML processes for performing one or more tasks on the predictions.

30. A non-transitory digital storage medium having a computer program stored thereon to perform the method for operating a user device, UE, for a wireless communication network, the method comprising:
performing prediction of one or more performance parameters,
generating a prediction report, like a CSI report, for reporting the predictions,
operating a plurality of processing cores or processing units (N_CPUs), like CSI processing units, wherein the prediction report is associated with a certain CPU occupation (O_CPU) indicating a number of processing units (N_CPUs) operated simultaneously for generating the prediction report,
having access to a plurality of Artificial Intelligence, AI, cores or Artificial Intelligence/Machine Learning, AI/ML, processing units for running one or more AI/ML processes for performing one or more tasks on the predictions,
when said computer program is run by a computer.
